(19) United States
(12) Patent Application Publication
(10) Pub. No.: US 2009/0253113 A1
(43) Pub. Date: Oct. 8, 2009

(54) Methods and systems for facilitating learning based on neural modeling

(76) Inventor: Gregory Tuve, Atlanta, GA (US)

Correspondence Address: Ballard Spahr Andrews & Ingersoll, LLP, SUITE 1000, 999 PEACHTREE STREET, ATLANTA, GA, 30309-3915, US

(21) Appl. No.: 11/990,797

(22) PCT Filed: Aug. 25, 2006
(86) PCT No.: PCT/US2006/033285

§ 371 Date: Jun. 3, 2009

Related U.S. Application Data
(60) Provisional application No. 60/711,116, filed on Aug. 25, 2005.

(51) Int. Cl. G09B 7/00; G09B 5/00

(52) U.S. Cl. 434/327

(57) ABSTRACT

Methods and systems for promoting learning by presenting multiple concepts and forcing the viewer to imagine the relationship between them. Students can take notes by choosing clues and answers as they study. A flowchart indicating a teaching method is illustrated in FIG. 1 Oc. A teacher can begin by opening an exercise (1001) (a set of mindsets to be shown to the class). The teacher can expose all the clues in the mindset (1002), then pause, allowing the students to consider the relationship between the clues in mindset (1003). The teacher can then expose a set of possible multimedia answers, so each student can vote with individual classroom voting devices (1005). Answers can be presented in a format which allows the voters to choose multiple correct answers for a given clue list. The student responses can be recorded (1007). This method can repeat until the test is completed.

### CROSS REFERENCE TO RELATED PATENT APPLICATION

This application claims priority to U.S. Provisional Application No. 60/711,116 filed Aug. 25, 2005, herein incorporated by reference in its entirety.

### BACKGROUND OF THE INVENTION

The Socratic Method (teaching by asking pointed questions) is preferred by educational experts because it holds a student's attention, directs the student's attention to key concepts, and spotlights misconceptions that manifest as inconsistent answers. As computers came of age, educational experts designed software packages that imitated the Socratic Method. The resulting software was focused on narrow subject areas so that exposition could be matched with questions and answers. Each new subject required new exposition, new questions, new answers, and often—a new computer program. Unlike Socrates himself, the computer programs were largely unable to adjust their questioning to expose student misconceptions. Students often could not understand why a given answer had been labeled wrong. Students were instructed to buy custom software products that would become obsolete on the last day of each semester.

Designs for general purpose study aids revolved around the flashcard model, which was attractive for three reasons: 1) the software would be useful even after the current semester; 2) individual flashcards could not be overlooked, which made for thorough reviews; and 3) well-known cards could be set aside, reducing the student's remaining workload. These systems often judged answers containing synonyms and typing errors “incorrect.” Flashcard learning was founded not on understanding but rather a brittle alternative called, “rote memorization” which fostered misconceptions and left students helpless when confronted with novel questions.

Students who shunned flashcard systems were forced to review many things they already understood in time wasting efforts to locate the few concepts that actually needed review. Those with questions had trouble finding the corresponding passages within materials they had already studied and even within their own notes. Numerous studies showed that learning activities which supplemented the written word with images, sound, and video resulted in better comprehension and longer retention.

Instructors need a system that helps teachers convert almost every fact into a Socratic question. Students need a system that helps them convert their notes into Socratic self-tests. Both need a system that dovetails and resonates with the architecture of memory itself.

### SUMMARY

Memory Weaver™ is methods and systems for promoting learning by presenting multiple concepts and forcing the viewer to imagine the relationship between them. Memory Weaver™ can be used by students to study text books, web sites, power point presentations, or more exotic information sources such as EKG readouts and unfamiliar software interfaces. Students can take notes by choosing clues and answers as they study. Memory Weaver™ can be used by professors/teachers to teach. In this use, a professor can expose the clues, pause a second, or two to let the students think about them, then expose the answer, and explain how it summarized the clues. In such use, the professor can choose the clue and answer stimuli. A professor can also use Memory Weaver™ in concert with classroom voting devices (“Clickers”) and multiple choice tests to assess the degree to which the students understand the lesson under way (or prior lessons). Memory Weaver™ can also be used by other professionals to analyze situations, analyze information, plan strategies (military, competitive, etc), and to study many other types of information. For example, a defense lawyer might use it to search for inconsistencies in witness testimony, plan a cross examination, and plan a closing argument.

Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIGS. 1a, b, and c are exemplary mindset interfaces for practicing the disclosed methods.

FIG. 2a is a more detailed exemplary mindset interface for practicing the disclosed methods.

FIG. 2b is an enlarged view of a mindset history control.

FIG. 3a is an example of two complete mindsets.

FIG. 3b illustrates the relationships and associations created by mindsets.

FIG. 4 illustrates the neural basis for the effectiveness of the methods.

FIGS. 5a, b, c, and d illustrate an exemplary implementation of the disclosed note taking method.

FIGS. 6a, b, and c illustrate a cropping interface.

FIGS. 7a and 7b illustrate a derivative exercise designer interface.

FIG. 8a illustrates steps in an exemplary stimulus labeling method.

FIG. 8b illustrates exemplary interfaces for an exemplary stimulus labeling method.

FIG. 9 illustrates an exemplary demonstration of an implementation of the disclosed grammar and slaved text stimuli method.

FIGS. 10a, b, and c are flowcharts describing steps in exemplary methods.

FIGS. 11a and b are flowcharts describing steps in exemplary methods.

FIGS. 12a and b are exemplary interfaces for a page stamp.

FIG. 13 is an exemplary operating environment.

### DETAILED DESCRIPTION OF THE INVENTION

Before the present methods and systems are disclosed and described, it is to be understood that this invention is not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout this application various menu options are presented. These menu options are not limited to the phrases described herein. Also, throughout the application where interaction between a user and system is described, such interaction can be via any form of human computer input device.

The present invention may be understood more readily by reference to the following detailed description of preferred embodiments of the invention and the Examples included therein and to the Figures and their previous and following description.

### I. Methods—Generally

Provided are methods of teaching a student, comprising providing a first exercise comprising at least one mindset, wherein the at least one mindset comprises a first clue, a second clue and an answer, wherein the first clue and the second clue of the at least one mindset have at least one relationship and wherein the at least one relationship is revealed by the answer, exposing the first clue and the second clue, and exposing the answer. An exercise can comprise more than one mindset. More than one exercise can be provided.

Clues and answers can be, for example, plain text, rich text, an image, an animation, a video clip, a sound clip, a music clip, a speech clip, a hologram, a scent, direct brain stimulation, and a compound clue. Clues and answers can be input into a computer system in a variety of ways, including but not limited to, speech recognition, keyboard entry, screen capture, and the like. Clues and answers can have a cover, preventing a user from experiencing the clue or answer until the cover is removed.

Mindsets, clues, answers, and covers can be selected from a library. There can be individual libraries or a collective library. Mindsets, clues, answers, and covers can each be obtained from a sharing system, such as a mindset sharing system, a stimulus sharing system, and a cover sharing system. These can be separate sharing systems or they can be obtained from a single, unified sharing system. Examples of sharing systems include, but are not limited to, peer-to-peer networks, centralized downloading systems, and the like.

Clues can be exposed in a specific order, for example, the first clue can be exposed before the second clue. After a clue is exposed, the clue can be edited. Similarly, after an answer has been exposed, the answer can be edited. After exposing the clues and the answer, the order in which the clues are presented can be modified.

A mindset can further comprise a third clue, wherein the third clue has at least one relationship to at least one of the first clue and the second clue. The first clue, the second clue and third clue can share at least one relationship.

The first exercise can further comprise a first mindset having a first mindset answer, a second mindset having a second mindset clue, and wherein the second mindset clue is a copy of the first mindset answer.

The answer exposed can be a possible answer and the method can still further comprise receiving a vote submitted by a student regarding the correctness of the possible answer and determining whether the student understood the at least one relationship under study based on the vote received.

The method can further comprise assigning a grade to the student based on the vote submitted by the student. An efficacy score can be assigned to a mindset based on the correctness of the student's vote. Furthermore, a historical performance for a student can be retrieved.

Related, but scattered, mindsets can be linked in an ordered loop allowing a user to traverse the loop by visiting all the related mindsets before returning to a starting mindset. Mindsets can be selectively submerged by a student wherein the mindset is not available to the student until a predetermined time has passed. A user can modify an order of a plurality of mindsets.

Also provided are methods of taking notes, comprising identifying a fact, decomposing the fact into two concepts having at least one relationship, converting each concept into a clue, creating an answer which reveals the at least one relationship between the first clue and the second clue, and associating the first clue, the second clue and the answer in a mindset. A second mindset can be generated from a second fact.

The method can further comprise decomposing the fact into a third concept having at least one relationship to the two concepts, converting the third concept into a clue, and associating the clue in the mindset.

Clues and answers can comprise a page stamp indicating the source of the fact. Clues and answers can be, for example, plain text, rich text, an image, an animation, a video clip, a sound clip, a music clip, a speech clip, a hologram, a scent, direct brain stimulation, and a compound clue. Clues and answers can be input into a computer system in a variety of ways, including but not limited to, speech recognition, keyboard entry, screen capture, and the like. Clues and answers can have a cover, preventing a user from experiencing the clue or answer until the cover is removed.

Mindsets, clues, answers, and covers can be selected from a library. There can be individual libraries or a collective library. Mindsets, clues, answers, and covers can each be obtained from a sharing system, such as a mindset sharing system, a stimulus sharing system, and a cover sharing system. These can be separate sharing systems or they can be obtained from a single, unified sharing system. Examples of sharing systems include, but are not limited to, peer-to-peer networks, centralized downloading systems, and the like.

Clues can be associated in a specific order, for example, the first clue can be configured such that it is exposed before the second clue. After a clue is associated, the clue can be edited. Similarly, after an answer has been associated, the answer can be edited.

A mindset can further comprise a third clue, wherein the third clue has at least one relationship to at least one of the first clue and the second clue. The first clue, the second clue and third clue can share at least one relationship.

The first exercise can further comprise a first mindset having a first mindset answer, a second mindset having a second mindset clue, and wherein the second mindset clue is a copy of the first mindset answer.

Related, but scattered, mindsets can be linked in an ordered loop allowing a user to traverse the loop by visiting all the related mindsets before returning to a starting mindset. Mindsets can be selectively submerged by a student wherein the mindset is not available to the student until a predetermined time has passed. A user can modify an order of a plurality of mindsets.

The method can further comprise linking related but scattered mindsets in an ordered loop allowing a user to traverse the loop by visiting all the related mindsets before returning to a starting mindset.

A student's past performance can be conveyed. Conveying a student's past performance can comprise using a plurality of vertical lines having a plurality of colors, organized with a false perspective.

### II. Mindsets

a. Clues and Answers

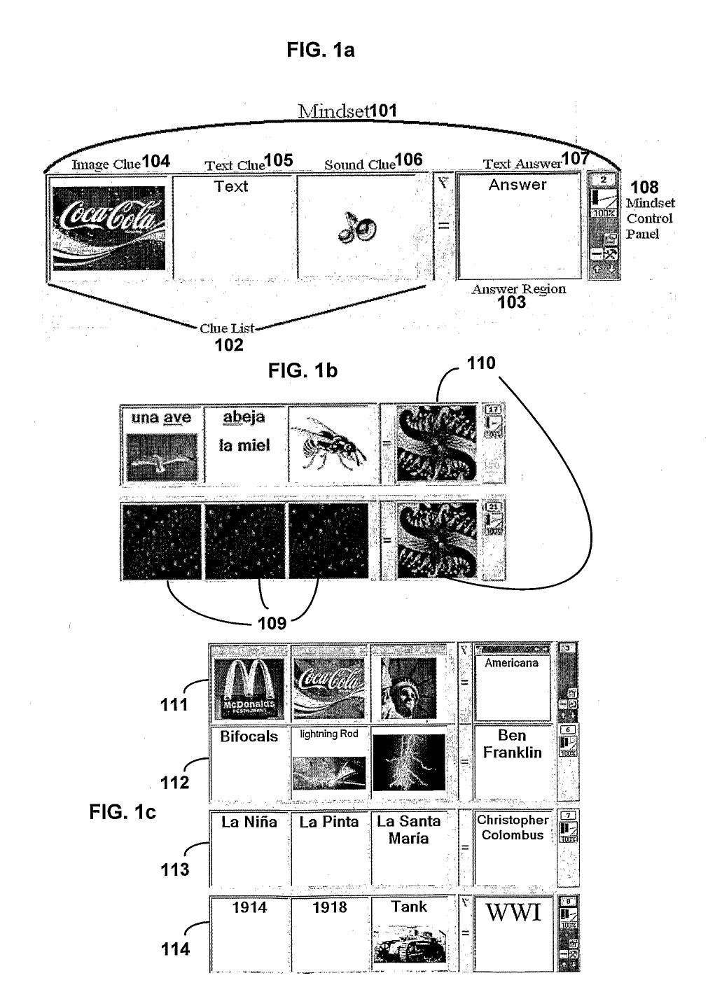

An example of an implementation of Memory Weaver™ can be seen in FIG. 1a. In this example, concepts can appear on the left as clues (104, 105, 106) while an answer 107 can appear on the right. The answer 107 can be a summary, i.e., something that describes a relationship between the clues (104, 105, 106). The answer 107 can be temporarily hidden. After studying the clues (104, 105, 106), a user (student, teacher, analyst, strategist, or other intellectual laborer) can expose the answer 107 to verify it was correctly imagined.

Clues (104, 105, 106) and answers 107 are artificial categories for stimuli. A stimulus on the left can be a clue (104, 105, 106). Moved over to the right, a stimulus can be an answer 107. The entire set of stimuli can be referred to as a, Mindset 101. Mindsets 101 are not limited to just four stimuli, but rather, can be any number of stimuli capable of promoting learning.

There is no material difference between clues (104, 105, 106) and answers 107; both are stimuli. Possible stimulus types can include images 104 (all file types, including animated gif), text 105 (including rich text), sounds 106 (all file types), short video clips, and more exotic stimuli such as holograms, scents, and direct stimulation of the brain. A clue list 102 contains the clues (104, 105, 106). Clue list 102 may refer either to the container of the clues (104, 105, 106) or the collection of clues (104, 105, 106), depending on context. The clue list 102 can contain any number of clues (104, 105, 106) but the optimum number of clues is 3. The answer region 103 can contain an answer 107. The mindset 101 contains the clue list 102, the answer region 103, and a control panel 108. Both the clue list 102 and the answer region 103 can be “drop zones” for clipboard text, images, sounds, and files. As shown in FIG. 1b, clue covers 109 and answer covers 110 may both be referred to as, stimulus covers. Stimulus covers can provide a user with intuitive information about where the user is within the exercise. The image used as a stimulus cover is customizable.

Mindsets 101 can be contained by exercises and may be listed one after the other. When mindsets 101 are listed, the stimuli in one may tend to give away the answer 107 in another. Stimulus covers can prevent this problem. Answer covers 110 prevent the answer 107 from being exposed before all of the clues (104, 105, 106) have been considered. Clue covers 109 help prevent a second mindset 101 from interfering with a first mindset 101 when the second mindset's 101 clues tend to give away the answer to the first mindset 101.

Stimuli can be revealed one at a time (alternatively, stimuli can be revealed in groups) by a user interfacing with a computer system via an input device. Such interfacing can be accomplished by clicking on clue covers 109 with a mouse, pressing a key on a keyboard, tapping a touchpad, and the like. The user can also reveal answers 107 and move not only from stimulus to stimulus, but from one mindset 101 to the next with similar interfaces.

FIG. 1c provides further examples of complete mindsets. The examples in FIG. 1c reveal three clues and one answer that summarize a relationship between the clues. In 111, the clues are objects having to do with America, or “Americana.” In 112, the clues are things Ben Franklin either invented or was involved with. In 113, the clues are the names of the three ships that traveled with Christopher Columbus to the new world. In 114, the tank was invented during World War I (between 1914 and 1918).

b. Mindset Features

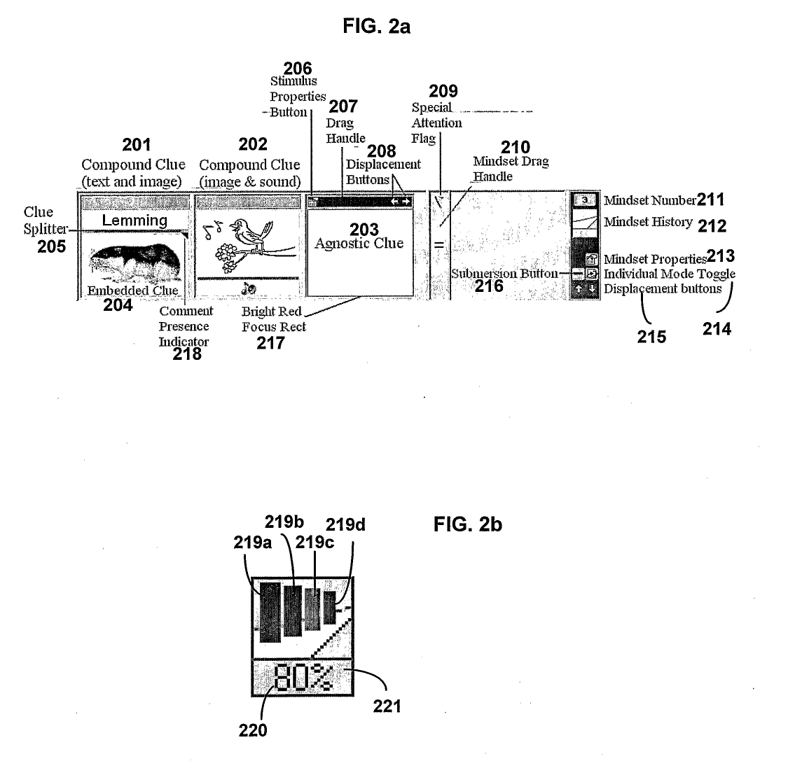

FIG. 2a provides further detail of an exemplary Memory Weaver™ implementation. A mindset 101 can comprise a compound clue 201. A compound clue is a clue comprising multiple stimuli. For example, a compound clue can comprise text and an image. The compound clue 201 comprises two stimuli, a text stimulus that says “Lemming”, and an image stimulus depicting a lemming. Any individual part of a compound clue is referred to as an embedded clue. In compound clue 201, the image of the lemming is an embedded clue 204. The compound clue 202 comprises an image stimulus and a sound stimulus. The sound stimulus is embedded in the compound clue 202 (presumably a birdsong). When the compound clue 202 is uncovered, the sound will be sent to the computer's speakers. Software options allow embedded sound clues to be rendered invisible. Any stimulus type may be combined with any other stimulus type to make a compound clue. An agnostic clue 203 is created when the user inserts a stimulus without specifying its type. When the user pastes or drags clipboard content into an agnostic clue 203, Memory Weaver™ interprets the clipboard content and chooses an appropriate child of the stimulus class: image, animated gif, text, sound, video clip, hologram, etc. If the user begins typing, the agnostic clue 203 becomes a text clue. After the type of stimulus has been selected, subsequent drag and paste operations can create compound clues with one embedded clue of the original type and additional clues of the pasted types. An agnostic clue 203 can be an agnostic stimulus inside a clue list (as opposed to inside an answer region 103).

The clue splitter 205 provides a means for adjusting the proportion of the clue allotted to each of the embedded clues. Compound stimuli can report the proportions of any given embedded stimulus to any of several cropping tools so that proportionate cropping rectangles and diagonal guidelines can be calculated when the user wishes to focus on a particular feature of an image by cropping away the feature's background. The stimulus properties button 206 forces the display of a stimulus-properties editor which shows information about the stimulus such as stimulus source, key words, and comments. The stimulus source is the location from which the stimulus was acquired, for example, a URL, a Path and Filename combination, the Stimulus Library shipped with the software, an adjunct Library provided with a textbook by a publisher, and the like. Key words are text strings describing the nature of a stimulus so that the stimulus can be readily retrieved from a stimulus library containing a plurality of stimuli (images, sounds, etc.). Key words for the lemming shown in compound clue 201 might be: “Lemming,” “rodent,” “mammal,” “cute,” “furry animal,” and so on. Finally, individual stimuli can be commented. For example, “Not to be confused with the Australian, Leymeene—which is a marsupial.” All the comments in an exercise can be aggregated for inspection purposes.

A drag handle 207 allows a user to displace a stimulus. The user may wish to change the order of the clues (201, 202, 203) within the current clue list, make a clue an answer by moving it to an answer region 103 (and vice versa), drag it to a temporary storage area called the scratchpad, or drag it into another mindset or another exercise. Displacement buttons 208 allow a stimulus to be displaced one position at a time. When the stimulus is moved to its new position, it takes the mouse pointer with it, allowing the user to move the stimulus again without relocating the mouse pointer to the new stimulus position. The displacement buttons can be “overloaded” so that shift-click moves the clue to the far end of the clue list. A clue may be displaced to the far right, and then displaced one more time to move it into the answer region—with just one mouse movement and a few clicks. Appropriate keyboard shortcuts supply equivalent functionality.

A special attention flag 209 can take on any of several colorations to indicate that a particular mindset belongs to a special group. A user might flag a mindset for special attention for several reasons, including: the mindset is a question that needs to be answered before a test; the user wants to study the mindset more often than the mindsets surrounding it; the user wants to be sure to study the mindset right before taking a test; the mindset is a member of a class of mindsets related to a particular topic. A Derivative Exercise Designer (described below) can be used to isolate all mindsets which have identical flags 209. For example, in the minutes preceding a test, the user might isolate all the mindsets flagged for “pre-test review.” To flag a mindset, the user clicks the flag 209 which exposes a context menu listing the various ways in which it can be flagged. Appropriate keyboard shortcuts also supply flagging functionality.

A mindset drag handle 210 allows a mindset to be dragged to a new location within the exercise, in another exercise, or somewhere else. Mindsets are assigned a mindset number 211. The mindset numbers 211 are consecutive so that the user understands where he is within a long exercise. When mindsets are submerged (described below), a jump in the mindset numbers 211 warns the user that he has deliberately hidden some of the mindsets within the exercise. When a preceding mindset is hidden the subsequent mindset numbers 211 can have unusual coloring, (such as a combination of highly contrasting colors) to make the subsequent mindset numbers 211 stand out.

The mindset history control 212 can use false perspective to convey information about the user's past performance when exposed to the mindset. User performance can be displayed in LIFO (Last In, First Out) order. The mindset history control 212 background coloration can convey the idea of a road going back in time. The mindset history control 212 illustrated in FIG. 2b indicates the following:

1) The mindset has been reviewed four times (four vertical bars, 219a, b, c, d).
2) The user remembered the correct answer during three out of the four attempts. (Three of four bars are green 219a, b, d.)
3) The user had no trouble recalling the answer on the first review but failed to recall it on the second review (second bar from back is red, 219c).
4) The user has not missed the answer since then (leftmost two bars green 219a, b).
5) The user would likely answer a related test question correctly should the user take a test at this point in time (most recent bars green 219a, b).
6) The most important performance results are the most recent (foreground bars larger than background bars and 80% 220 weighted average instead of 75%).
7) This mindset does not need modification (blue background 221 of the 80% 220 figure). Other colors can be: Red—mindset should be modified, yellow—minidset may need modification, green—mindset definitely does not need modification. The learning principle behind the entire interface design is associative. In this situation, reviewing a mindset which does not bring the answer to mind has no benefit and can be detrimental if it consistently brings the wrong answer to mind so the system can provide color hints for new users which help them assess the need to change the mindset so as to make it more effective at triggering the correct recollection. A weighted average is not entirely sufficient to set the background color of the percentage Figure since missing a mindset on the first review is somewhat common and not cause for alarm. In this case, a logical test can set the background color of the percentage to yellow (caution) rather than red.

Memory Weaver™ can monitor the location of the focus and increase the review count after the focus enters the answer stimulus under the assumption that the user imagined the correct answer since this is the usual outcome. When a user realizes he has not imagined the correct answer, the user can click on a history control to change the newest outcome from correct to incorrect, changing the newest bar's color from green to red. An appropriate keyboard shortcut supplies equivalent functionality.

A mindset properties 213 button can open the mindset properties editor, in which mindset properties may be reviewed and changed as necessary. The editor provides access to mindset comments—among other things, and is covered in detail below. The mindset properties 213 button can blink when a mindset comment is present and when the mindset contains the focus. An appropriate keyboard shortcut supplies equivalent functionality. Individual mode toggle 214 also referred to as “Mindset Mode Toggling Button,” can be used in a review mode where the currently focused mindset is switched into edit mode so that any operations which are not compatible with review mode can be performed. This mode should be contrasted with the full-blown exercise edit mode in which all mindsets are switched to edit mode. An appropriate keyboard shortcut supplies equivalent functionality.

Displacement buttons 215 are an aid to touchpad users. The mindset displacement buttons can be used to relocate the mindset without dragging. Doubly overloaded, these buttons can move the mindset one up or one down (click), move the mindset to the top or the bottom of the exercise (shift click), and move the mindset to a random location above or below the current location (ctrl+click). Mindsets most often need relocation when one interferes with another. The mindset reviewed first may make recollection of the answer to the next excessively easy because they are related. When this is the case, the user may not care where the mindset is as long as it isn't in the original location. Thus a location chosen randomly by the software may be acceptable. In other cases, the user may wish to place the mindset at the top of the exercise where it will get more attention as most users prefer to start their reviews at the top of the exercise or at the bottom of the exercise for similar reasons. A user who realizes an answer to a mindset was recalled merely because of its proximity to a prior mindset may wish to locate the mindset at a random point below the mindset's current position so that the user can attempt the mindset again after the user has had several minutes to forget the answer. The user may wish to locate the mindset randomly above the current location so that the mindset will not be seen again until the next review, at which time the user can reliably ascertain whether or not he is at all prone to forgetting the answer. Appropriate keyboard shortcuts supply equivalent functionality.

Submersion button 216 is used whenever a user determines regular review of a particular mindset can be suspended. Instead of hiding the mindset forever and exposing the user to the possibility of forgetting the mindset content, the user can select a “submersion duration.” For example, a mindset submerged for a month will automatically “resurface” a month later so that the user can review the mindset again before the user has completely forgotten it. An appropriate keyboard shortcut can trigger a dialogue which supplies equivalent functionality.

A bright red focus rectangle 217 conveys important state information to the user. Among other things, this information helps the user choose appropriate keyboard shortcuts and generally predict how the software will behave when responding to a given mouse or keyboard input. A comment presence indicator 218, shown as a bright red triangle, indicates the presence of a comment—in this case—an embedded clue 204 comment. When the embedded clue 204 is focused, a keyboard shortcut can reveal the comment and other clue properties.

c. Proper Mindset Design

Taking notes with Memory Weaver™ is best understood with several examples. Memory Weaver™ can be used to take notes on any fact which can be formulated as a sentence. The paragraph below is typical of what a student might encounter while reading about science history.

Unlike Fahrenheit, Celsius chose to anchor the ends of his temperature scale at the freezing and boiling points of water so Fahrenheit's 32 degrees corresponds to zero on the Celsius scale, while 212 degrees Fahrenheit equals just 100 degrees Celsius. Celsius concluded his scale would be easier to work with if it were divided into just 100 parts so it is often called the centigrade scale.

The best stimuli are key concepts. Usually these are nouns, names, numbers, or dates (words in bold above). There is no defined rule, but it is generally bad technique to place any form of the answer in the clue list.

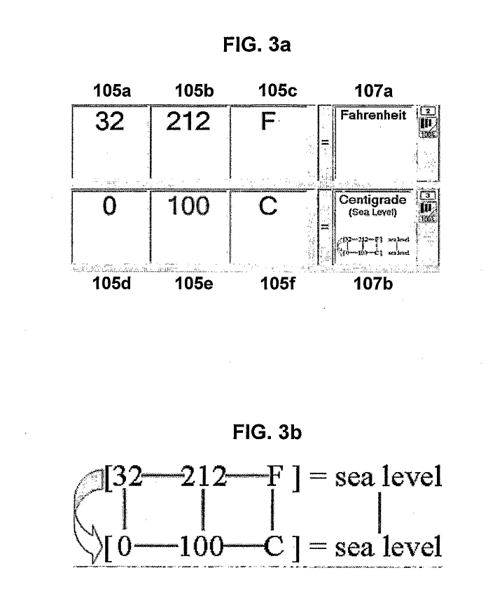

Stimuli can be used from the above paragraph to create two mindsets as shown in FIG. 3a. The answers 107a, b can be Fahrenheit and Celsius. The two sets of numbers representing the upper and lower temperature values can be selected as clues 105a, b, d, e. Also the letters representing the abbreviations for the answers can be selected as clues 105c, f. The answers 107a,b encompass all the respective clues 105a, b, c, d, e, f. The answers 107a,b summarizes the clues 105a, b, c, d, e, f. The user can further color “100” in the clue 105e and “Cent” in the answer 107b, for example, red to draw attention to the reason it is called the centigrade scale. The user can also color the words, “sea level” blue (the color of the sea) in answer 107b to elaborate the association since the reference points Celsius chose for his temperature scale are valid only at sea level since the higher the altitude, the sooner water boils and the harder it is to freeze water.

In FIG. 3b, the lines show the associations that are either formed or strengthened by composing and reviewing the two mindsets shown in FIG. 3a. Through this association formation and strengthening, Memory Weaver™ builds understanding.

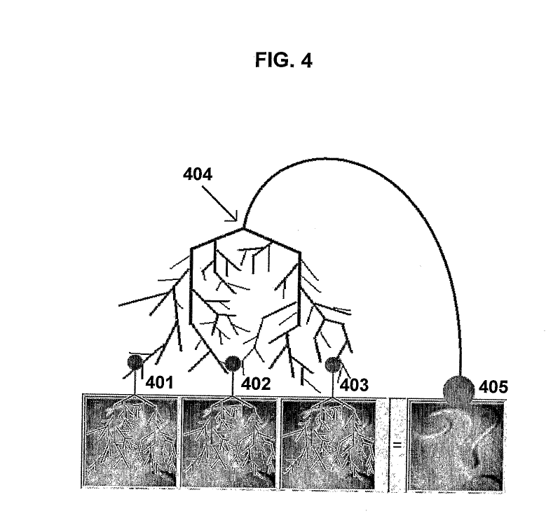

A partial explanation of the reasons for Memory Weaver™'s efficacy is seen in FIG. 4. The branching lines of this Figure describe four neurons (401, 402, 403, 405)—three in the input role (401, 402, 403), and a fourth in the output role 405. Nerve impulses traverse the dendrites (branched lines) up from the neurons (401, 402, 403) at the bottom left, over and down neuron 405 to the terminal at bottom right. Any given neuron in the human brain will generally not “fire” unless it has received three excitatory stimuli at about the same time. When a neuron does fire (upon receipt of the 3rd stimulus), it stimulates neural tissues which essentially hold the answer. Effectively the three inputs from the neurons (401, 402, 403) merge at the point 404. Detail is lost between the input and output stages of this process, making the output nerve impulse a summary. Mindsets work because they fit the firing requirements of neurons and groups of neurons. Therefore a proper mindset has details on the left and a summary on the right.

### III. Memory Weaver™ in the Classroom

a. Teaching

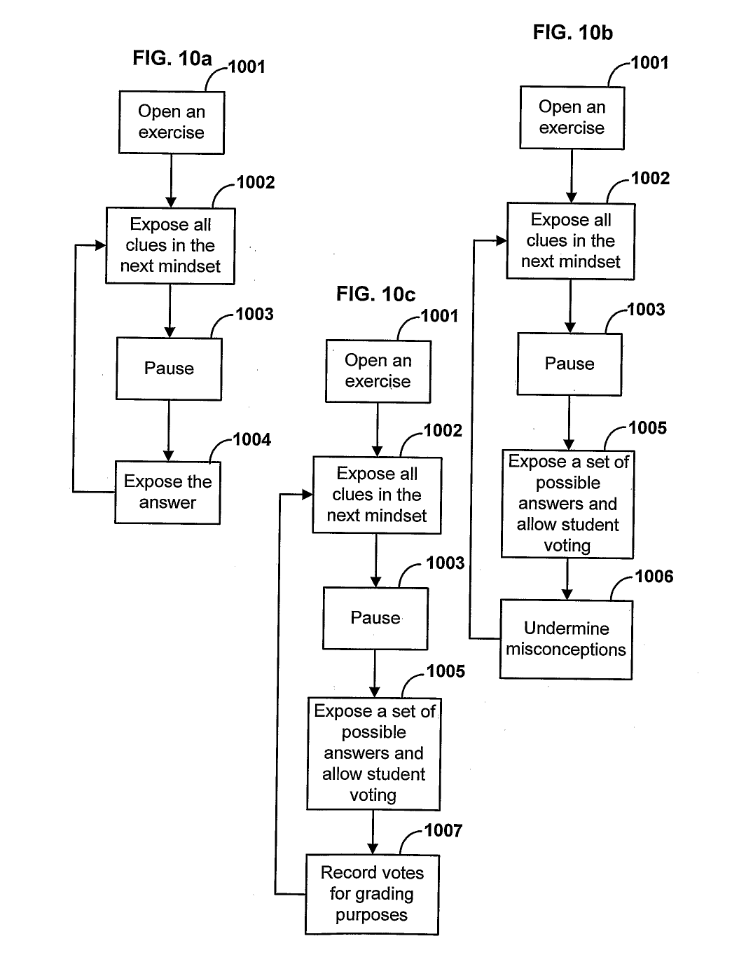

A flowchart indicating an exemplary teaching method utilizing the disclosed invention is illustrated in FIG. 10a. A teacher can begin by opening an exercise 1001 (a set of mindsets to be shown to a class). The teacher can then proceed to expose all the clues in the first/next mindset 1002. The teacher can pause, allowing the students to consider the relationship between the clues in the mindset 1003. The teacher can expose the answer and explain the relationship between the clues and the answer 1004. Alternately the teacher may explain: How the clues are related to each other and how the answer encodes this relationship, how each clue relates to the answer individually, how pairings of clues relate to other clues within the mindset's clue list or the mindset's answer, how members of a given clue pair are related to each other, how embedded clues are related to each other or other stimuli, or how the clues or answer in one mindset are related to one or more stimuli in one or more other mindsets. This method can repeat by returning to 1002 until the exercise is completed. This method can be practiced in an automated fashion, without the use of a teacher.

b. Teaching with Student Feedback

A flowchart indicating an exemplary teaching method utilizing the disclosed invention is illustrated in FIG. 10b. A teacher can begin by opening an exercise 1001 (a set of mindsets to be shown to a class). The teacher can then proceed to expose all the clues in the next mindset 1002. The teacher can pause, allowing the students to consider the relationship between the clues in the mindset 1003. The teacher can expose a set of possible answers so each student can vote with anonymous or individually assigned classroom voting devices (clickers, ballots, and the like) 1005. Relying on the feedback provided by both correct and erroneous answers, the teacher can: determine that the subject being taught is now understood well enough that the teacher can move on to the next subject, ask students who chose incorrect answers to explain their reasoning so that the teacher may draw the attention of the class to mindsets which show why this reasoning is fallacious, use the feedback gathered from teaching the current subject to prior classes to select arguments and/or mindsets that will persuade the erroneous students to abandon their misconceptions, or implement other strategies known in the art to undermine the misconceptions which led to the erroneous responses registered during the voting 1006. This method can repeat by returning to 1002 until the exercise is completed. This method can be practiced in an automated fashion, without the use of a teacher.

c. Testing

A flowchart indicating an exemplary teaching method utilizing the disclosed invention is illustrated in FIG. 10c. A teacher can begin by opening an exercise 1001 (a set of mindsets to be shown to the class). The teacher can then proceed to expose all the clues in the first/next mindset 1002. The teacher can pause, allowing the students to consider the relationship between the clues in the mindset 1003. The teacher can expose a set of possible “multimedia” answers (images, sounds, rich text, etc.) so each student can vote with individual classroom voting devices (clickers, ballots, and the like) 1005. Answers can be presented in a format which allows the voters to choose multiple correct answers for a given clue list. The student responses can be recorded 1007. This method can repeat by returning to 1002 until the test is completed. The recorded responses can be used for grading and/or used to refine automated teaching protocols. This method can be practiced in an automated fashion, without the use of a teacher.

d. Taking Notes

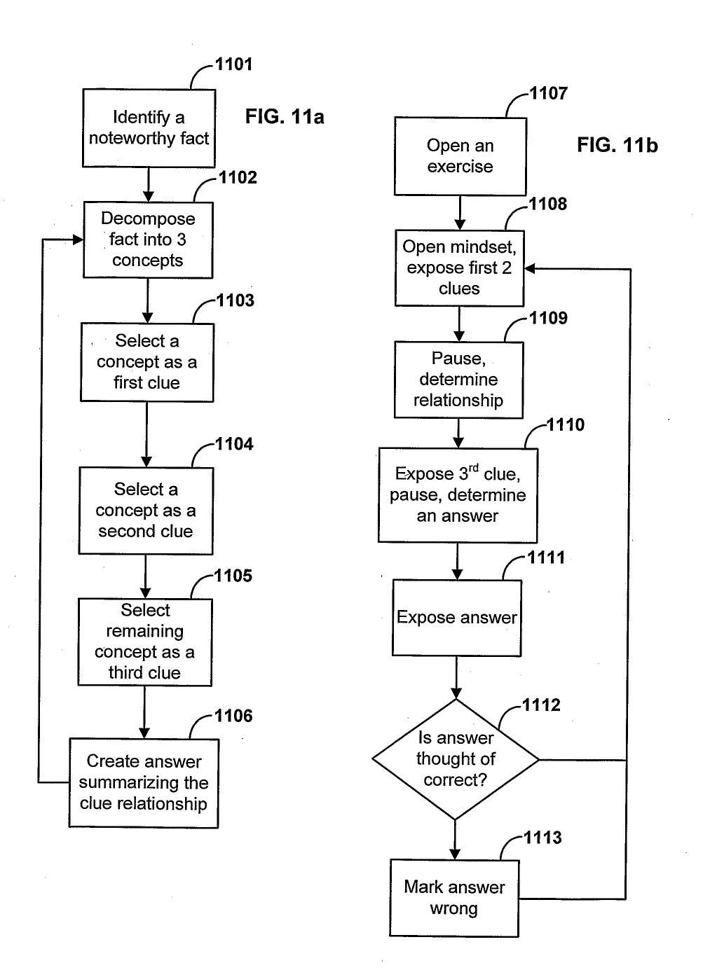

A flowchart indicating an exemplary note taking method utilizing the disclosed invention is illustrated in FIG. 11a. A note-taker can begin the method by identifying a noteworthy fact in the material being studied 1101. The fact can be mentally decomposed into a set of discrete concepts bound by a single relationship 1102. The set can be one or more concepts. In this example, three concepts are used. The note-taker can then decide which of the three concepts will be the first of the three clues and create the first clue 1103. The note-taker can then decide which of the remaining two concepts will be the second of three clues and create the second clue 1104. The note-taker can then create the third clue with the remaining concept 1105. The note-taker can decide how the relationship between the concepts in the clue list should be represented and create the answer, finishing a mindset 1106. This method can repeat by returning to 1101 until note taking is completed.

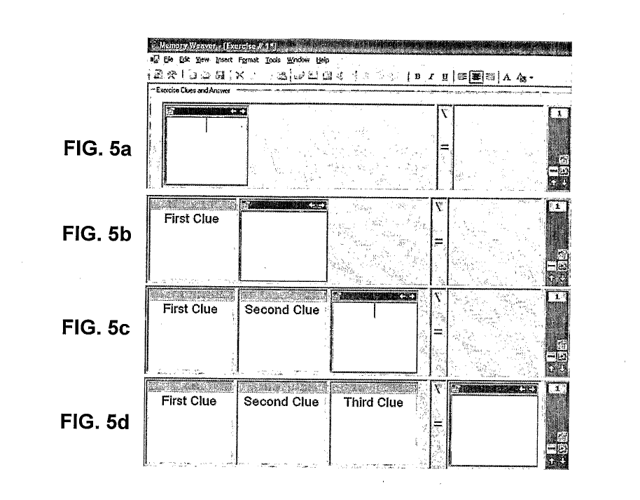

Memory Weaver™ can be utilized as a method for taking notes in edit mode. The method for taking notes can comprise selecting two or more stimuli as clues and selecting one or more stimuli as an answer, wherein the answer is a summary of the clues. FIG. 5a,b,c,d illustrates an exemplary interface for taking notes with Memory Weaver™. In FIG. 5a a new exercise has been started. The exercise, in turn, starts a first mindset, which in turn starts a first clue. The first clue can be typed into the first blank stimulus container or the stimulus container can be moved to the answer region wherein the stimulus contained plays the role of an answer. Alternatively, clues can be images, sounds, videos and combinations thereof. The user can then proceed, by clicking a mouse or pressing a button on keyboard or similar input device, to type in a second clue as shown in FIG. 5b. Clicking in the clue list region or answer region can create new blank stimuli containers for the user to populate. Finally, the user can type in a third clue as shown in FIG. 5c and proceed in similar fashion to create an answer as shown in FIG. 5d. If the answer is known before the clues, this method can be practiced in reverse. A user can draw custom graphics using various graphics creation and editing programs, then paste (or drag & drop) them into empty stimulus containers. Memory Weaver™ also has a built in image editor described below. Clipboard content may also be dragged on top of pre-existing clues to create compound clues (covered below). The exercise can be configured to automatically cover answer stimuli immediately after their creation.

In FIG. 5a the first stimulus container is empty, as such it is an agnostic clue, capable of adapting to any form of stimulus that is dropped or pasted in it (image, sound, video, text, etc.). After selecting a suitable image, the image file may be dragged and dropped on an agnostic clue, transforming it into an image clue. Image files stored on a hard drive (mass storage device) may also be dragged and dropped the same way. Double clicking an image can start an image editor.

The image editor automatically opens at the native resolution of the image to be edited—or the largest size which will fit the screen, whichever is smaller. The image editor can be used to crop images, bringing their most important features into prominence. It can also be used to reduce letterboxing (the white area at opposing sides of the original image within the clue). It can rotate images or be used to draw on them to highlight important features or show how two or more features are related. When image editing is complete, the user can send the modified image back to the original stimulus container. Modified images may also be sent directly to an image file by saving the image to the mass storage device. An image can be cropped without opening the editor by holding down an alt key and dragging out a cropping rectangle on an image.

As each image is brought into Memory Weaver™ (by insertion into a stimulus container), a copy is placed in Memory Weaver™'s library from which it may later be retrieved for use or reuse in a different mindset. Memory Weaver™ automatically captures each image's URL (or path and file name) and associates it with the image in the library for future reference. A copy of this source information is retained as text by the mindset itself so that a text search is likely to turn up the image. This allows a user to backtrack: first to the mindset containing a particular string, then to the “stimulus source” information, and finally back to the web site (or original folder) for the purpose of making a bibliographical entry or doing additional study. A, “stimulus source” is the place from which a stimulus was obtained while a “mindset source” is the source of the fact that the mindset encodes.

Images in web browsers may be dragged into Memory Weaver™ or sent into Memory Weaver™ by right clicking, and choosing “Send to Memory Weaver™” whereupon they are added to the scratchpad (and the library) to await their final disposition. When the Memory Weaver™ is not in use, these images are sent directly to the library from which they can later be retrieved by filing date and in other ways.

i. Image Capture Tool

The Inage Capture Tool is designed to allow users to rapidly capture snapshots of whatever is on a screen at a moment. These snapshots might be pulled from a website, a PowerPoint slide show, a spreadsheet graph, a flash animation, or even full-motion video. If Memory Weaver™ is not running, pressing the “send to Memory Weaver™” button sends the image to the library. “Save image to file” operates normally. The tool is especially handy for studying software interfaces.

To save user's time, the “send to Memory Weaver™” button (send-to) can be configured to perform one or a combination of the following actions:
capture the image,
send the image to Memory Weaver's scratchpad as an image stimulus,
copy the image to the clipboard,
copy the image to the library for future reference,
clear the capture window for the next snapshot, and
bring Memory Weaver™ to the foreground.

Thereafter, the user can drag the new image stimulus into a mindset immediately or switch back to the image source. Right clicking the send-to button brings up a configuration dialogue that modifies the automatic behavior by enabling or disabling any of the aforementioned actions. Placing an image on the clipboard automatically allows the user to drop it off in a full-featured graphics editor if necessary. The image capture tool can capture an image so that it may be cropped before being sent to Memory Weaver™ with the send-to button.

The image capture tool can have a drag handle that is used to move a main cropping rectangle around a screen. The main cropping rectangle may be resized & reshaped by dragging a corner around with a mouse. If the user should drag within the main cropping rectangle, a second cropping rectangle bordered only by a dashed line is created. It is this interior cropping rectangle to which “crop image” and “force proportional cropping” can apply. Double-clicking within the dashed rectangle can complete the crop. By default, the image capture tool can always be on top no matter which window has the focus.

An option can change the appearance and behavior of the image capture tool such that it can quickly crop multiple images (“rapid cropping mode”). In this mode, the image capture tool can draw a series of dashed rectangles. Each time the user releases the mouse button (completing a rectangle), the resulting image is sent directly to Memory Weaver™ (MW) without bringing MW to the foreground, and the cropping rectangle disappears so that the tool is ready for the next crop operation. If the user should decide the crop begun is unacceptable, the user can abort the cropping operation by, for example, pressing escape while the left mouse button is still depressed.

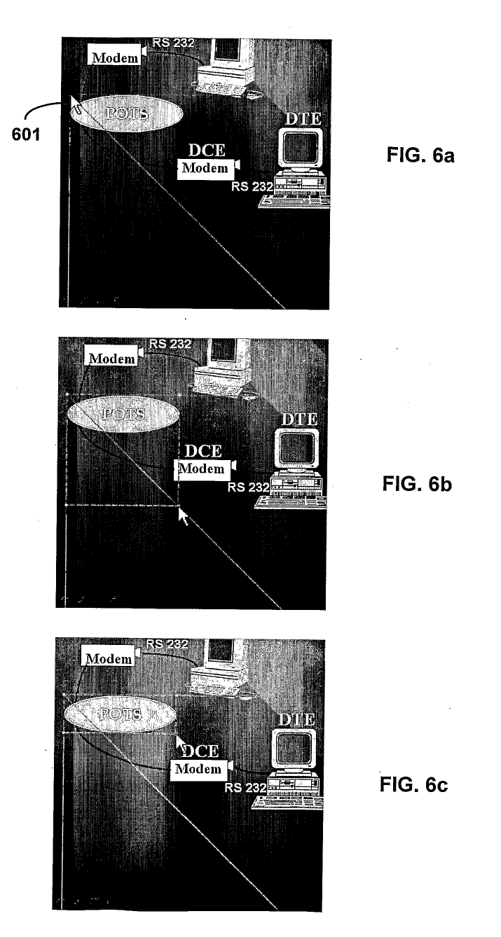

In the “rapid cropping mode,” the Image Capture Tool optionally provides a “precision cropping” mouse pointer 601 as shown in FIG. 6a. This special mouse pointer has the following advantages:
The user can tell exactly where the top and left edges of the cropping area will be before the process of drawing the cropping rectangle begins—so it need not be repositioned or redrawn several times.
The user can tell while drawing the rectangle exactly which mouse path will result in an image cropped to the same proportions as the stimulus in which it will be drawn. The path which results in a proportional crop is always the diagonal line.

The user can choose a precisely proportionate crop or decide to abandon the diagonal line and accept a letterboxed but predictable result with the object of interest displayed at maximum size.

A function key can automatically freeze the screen, intercept all keyboard and mouse input, and start the image capture tool in rapid precision cropping mode so the user has instant access to the most effective possible cropping no matter what is happening on his screen.

In FIG. 6b, the user has selected a proportional crop of the “POTS” image by following the diagonal line, and can release the mouse button and send the resultant image to Memory Weaver™. In FIG. 6c, the user chose to abandon proportionality but is still able to get a precisely cropped image. The image will be letterboxed. Afterwards, the user will have room in which to add a compound clue below or above this “POTS” image.

After the user completes the cropping rectangle, the mouse pointer reverts to its unusual appearance, ready for the next precision cropping operation. When the user is done, pressing a hotkey unfreezes the screen, restores the mouse pointer to its original appearance, and returns input to the underlying application (PowerPoint in this case).

Within the graphics editor cropping rectangles may be slid (by dragging) into the optimum position before the actual cropping takes place, mirroring the function of the image cropping tool. A proportional option can force the cropping rectangle to match the dimensions of the stimulus to which the image will be returned. Once the size, shape, and location of the cropping rectangle have been determined, the cropping operation may be completed by double clicking within the cropping rectangle or clicking the crop button.

ii. Working with Sounds

Sounds for use as stimuli can be gathered in several ways. For example, a user can right click a hyperlink to a sound, and then select “Send target to Memory Weaver™.” Memory Weaver™ dereferences the hyperlink and stores the sound in a sound clue on the scratchpad, simultaneously copying the sound to the library for future use or reuse. (The scratchpad can collect sounds and images regardless of whether or not the scratchpad is currently visible). If Memory Weaver™ is not running, the sound goes only to the library. The user can transfer sound files (and other multimedia files) from a folder to several different locations in Memory Weaver™ by copying and pasting or dragging. Finally, the user can look up sounds (and other multimedia stimulus types) in the library, described below.

e. Reviewing Notes

A flowchart indicating an exemplary note-reviewing method utilizing the disclosed invention is illustrated in FIG. 11b. A reviewer begins the method by opening an exercise (if one is not already open) or switching Memory Weaver™ into review mode 1107. As Memory Weaver™ enters review mode, it can cover up all the stimuli or cover up only the answers—depending on user preferences. The user may start his review with the mindset which currently has the input focus or move the focus to the mindset of his choice to start his review there. The reviewer can then expose the first two of three clues in quick succession 1108. The reviewer may pause, allowing any relationship between the two first clues to occur to him 1109. Exposure of the third clue may be followed by another brief pause during which an answer may occur to the reviewer 1110. Alternatively, the reviewer may choose to expose all of the clues without pausing after the first pair. He may expose them all simultaneously. After all clues have been exposed, the answer can be revealed 1111. The reviewer may actually ignore the answer revealed due to his certainty that he remembered it. The reviewer may determine that no answer occurred to him or that an incorrect answer occurred to him 1112. In both cases, he can mark the answer wrong 1113. If a mindset triggers recollection of the correct concept but not its exact representation within the answer, the user may often consider it correct. If exposing the clues triggered no recollection (erroneous or otherwise), the user should consider reducing the difficulty of the mindset by modifying its clues and answers. The user may decide not to modify the mindset on the basis that he has reviewed it only once or twice. He may substitute new clues for old ones, add new clues, modify existing clues, or delete a misleading clue. He may modify the answer or substitute a new answer. He may swap one of the clues for the answer. He may determine that the mindset is no longer necessary because he knew the answer well—even though it did not occur to him when the clues were exposed. In such a case, he would delete the mindset rather than try to improve it. If exposing the clue list triggered an erroneous recollection, the user should modify it (using the remedies above) so as to reduce its likelihood of triggering an erroneous recollection in the future. He may decide to ignore the problem on the basis that the mindset has been reviewed only once so far. The reviewer then returns to 1108 to review the next mindset.

Memory Weaver™ can be configured to open exercise files in review mode to avoid exposing the answers to mindsets against which the user may wish to test himself. A user in edit mode who wishes to review notes just entered can choose “review mode” from a menu. Afterwards, the user can press a hotkey to begin his review with the first of the newest mindsets. In other cases, the user may wish to pick up a review where he left off the day before (information which can be stored by Memory Weaver™ when the exercise is closed) or the moment before (information which can be stored by the current location of the input focus).

Each time the user hits the “tab” key, for example, a stimulus is exposed. This can also be done—out of order—with a mouse or similar device. The final stimulus exposed in each mindset can be the answer. Recollection of the answer usually takes place after the second or third clue is exposed. By default, the user always exposes the answer—either to confirm he remembered it, to see what it is, or just to tab to the next mindset (when the user is confident of the answer).

A user can recall an answer at or before the third clue over 90% of the time so the Memory Weaver™ can mark the mindset as correctly answered once the user has uncovered the third clue, by placing a green bar in the mindset history control. However, if the user fails to remember the answer, the user informs Memory Weaver™ by clicking the history control which turns the newest vertical bar red. A keyboard shortcut supplies equivalent functionality. The answer can re-cover itself automatically, allowing the user to test himself against any of the mindsets he reviewed recently.

A user doing deep study of something truly complex can shuffle mindsets after he knows them well in order to ensure that all mindsets are presented out of context. Related mindsets can be linked together so that they can be visited serially even after they have been scattered with the displacement buttons or the shuffle feature. A round trip control can accomplish this by treating a collection of related mindsets as a list of hyperlinks that returns the user to his starting point (the 37th mindset for example) in the exercise. A dialogue can help the user convert mindsets that all bear the same flag into a round-trip list. Longer round trip lists can be converted directly into derivative exercises (described below).

f. Revising Mindsets

It is during review mode that users usually discover the need to modify/improve/edit mindsets and occasionally the exercises (mindset order for example). Therefore all editing operations available in edit mode are also available in review mode. The key difference between the modes is that Memory Weaver™ gathers performance statistics on the user only during review mode.

i. Keyboard-Shortcut Focus Manipulation

Given any focus state, the object which will be acted upon (dragged, deleted, copied, pasted into, scrolled, edited, modified, enlarged, moved, commented, etc)—is whichever object has the input focus. Freshly created text clues will place the focus in the text automatically, where the focus remains until the enclosing mindset (the mindset being modified or created) no longer contains the focus, at which point the user must click a second time to reach the text itself. In general, escape can be a shortcut for focusing an object's container while F2 can be a shortcut for focusing the first object in a container's content and tab can be a shortcut for moving from object to object within a container. Clues embedded within compound clues, compound clues, whole clues, combinations of clues, answers, mindsets, and exercises are all objects which can accept the input focus. The location of the input focus can be moved with input devices using a variety of strategies known in the art.

g. Mindset Assessment

After completing the review of an exercise, the user may wish to scroll back through the exercise to reattempt missed mindsets—and possibly modify the mindsets as a consequence. This inspection can be the “acid test” for a freshly modified mindset. If the user does not recall the correct answer just a few minutes after making the latest change, the change was ineffective. The user can do this type of instant re-review because the answers re-cover themselves automatically (with default settings). The ordinary mindset-history control will have a solid green appearance. Those mindsets that have misses in their histories can be flecked with red and other colors, indicating potential problems and Memory Weaver™'s assessment of their severity. Bright warning colors allow the user to determine where potential problems lie at a glance. A user scrolling through an exercise can instantly tell that the older mindsets have been reviewed more often than the newest.

h. A Comparison of Review and Edit Modes

| Review | Edit |
|---|---|
| All Mindset Editing functions | All Mindset Editing functions |
| available | available |
| Optimized for review | Optimized for editing |
| Tab moves to next available | Tab creates stimulus if there is |
| stimulus | room |
| Focusing answer increments | Focusing answer doesn't change |
| review count | review count |
| Must click clue list to create | Click or hit tab to create new |
| new clues | clues |
| Clicking history control changes | Clicking history control does |
| color of vertical bar | nothing. |

In addition to the above differences, in Review Mode, Memory Weaver™ times the user from the point at which he exposes the third clue until he exposes the answer. The faster the user exposes the answer (on the way to the next mindset), the better he knows the mindset. The timing data is used in calculating how important it is to review a particular mindset again (the number that shows up at the bottom of the history control). The lower the number at the bottom of the control, the more important reviewing that particular mindset is.

### IV. Features

a. Menus

An “Anchored Context Menu” is a menu which is always present on a main menu bar but provides the list that would ordinarily be accessed by right clicking the object which is currently focused. The advantage of this is that the user need not remove his hands from the keyboard in order to access menu options specific to the current object. Similar functionality is often provided with a keyboard “application” key. These options can be reached through the anchored context menu the way all menu options are typically reached, for example:
Alt Highlight the menu bar.
C Extend the context menu.
Letter Letter struck corresponds to option desired (as with any other menu).
<Enter> Where the same letter appears on more than one option in the list.

A “quickfont” menu allows the user to choose the most commonly needed fonts quickly—and with the keyboard if desired. Most of these options affect the entire word surrounding an insertion point if nothing is highlighted so users can often skip the usual text-highlighting step. Colored fonts attract the eye to information which should not be overlooked. For example, a user might change the key word in a sentence to bright blue. The black option allows the user to rapidly go back to the original color when necessary. Larger font sizes can be used for answer titles, while smaller fonts are often used for ancillary information. It can be desirable to use a single letter for a clue, and in this case, one often wants the largest font that will fit the clue. When this is the case, an isolated-letter size is desirable. Typical font modifications known in the art can be implemented in this menu.

The answer and clue fonts can be applied with the “quickfont menu” but have attributes which are set in a preferences dialogue. Answers often contain one or more sentences so the associated fonts tend to be small and left justified while clue fonts tend to be large and centered. A selection of “Max Possible” can select a font based on the space remaining and the amount of text in a container. Appropriate shortcuts can be available for all options.

b. Additional Menu Options

i. Hiding and Un-hiding Perfect Mindsets

A perfect mindset is any mindset which has never been missed. Hiding such mindsets from the user allows the user to focus on items that need more review. Ordinarily, the perfect mindsets remain hidden only until the exercise is closed and reopened. If the user chooses unhide, the mindsets reappear immediately. This menu option increases friendliness for new users. The Derivative Exercise Designer (described below) provides much finer control over which mindsets get reviewed.

ii. Resurfacing Submerged Mindsets Versus Showing Submerged Mindsets

Mindsets ordinarily resurface on their own whenever their submersion (hiding) period expires. Choosing the “resurface” menu item turns off submersion prematurely and permanently as if the mindset had resurfaced on its own. The submersion period is reset, and the mindset rematerializes in its original location relative to other mindsets. Such a mindset displays its resurfaced status prominently until it has been reviewed again, at which point, its appearance reverts to normal.

A mindset which has been submerged can be viewed with, “Show all submerged mindsets.” This will allow the mindsets to be inspected without resetting their submersion timers. Afterwards, the mindsets can return to their hidden state to resurface days or months later. “Show all submerged mindsets” is counteracted by “Hide all submerged mindsets”—the only purpose for this menu item, since submerged mindsets are usually hidden anyway. When a submerged mindset is temporarily brought into view, it displays its submerged status prominently. Show all submerged mindsets can last until the exercise is closed and reopened.

iii. Start a new (blank) mindset and Create a new (blank) stimulus in the current mindset.

Mindsets are usually started from within edit mode by hitting a hotkey, such as tab, when the input focus is on the answer of the last mindset in the exercise. When users use the “Start a new mindset” menu option or its shortcut, they can add blank mindsets in the middle of an exercise. Users may also insert mindsets using a shortcut (for example, shift+ctrl+m). New stimuli are also created with tab in most circumstances. Blank embedded stimuli can be created by selecting “Create a new (blank) stimulus” when a stimulus is focused. Like all blank stimuli, these are agnostic stimuli capable of accepting text, images, sounds, video clips, and so on.

iv. Cascade, Tile Horizontal, Tile Vertical

Cascade, Tile Horizontal, Tile Vertical have the typical effect on Memory Weaver™ windows as is known in the art. Memory Weaver™ allows multiple exercise windows to remain open at one time but will not allow two with the same path and file name (to prevent inadvertent loss of data). Users can drag mindsets from one exercise to another to organize them better and can drag stimuli from one mindset to another, in lieu of searching out the same stimuli in the library.

v. Reset Scoring History

Users might reset the scoring history for an exercise if it has been a very long time since that exercise has been reviewed-say, six months or more. In such situations it would tend to provide misleadingly optimistic indications of the user's comprehension. To counteract this, Memory Weaver™ can use the length of time since a mindset was last reviewed in the calculation of a history control's “confidence level”, lowering the same to indicate that the mindset has probably been forgotten.

vi. Options Dialogue

The options dialogue can be divided into several tabs. A general tab can have two columns. Checks in the edit column describe which features should appear by default in edit mode. Checks in review column describe which features should appear by default in review mode. An option of perspective (mode) after loading the exercise can be available. This option is often toggled to review mode in order to prevent the user from accidentally exposing himself to answers when opening a file. Users can leave answers covered in both modes. The exact behavior of clue and answer covers after they have been reviewed is merely a matter of preference. The following options can also be on tabs.

Users can set font preferences for answers and clues separately since answers tend to be much longer than clues (up to three sentences). In some cases, a user may check the max possible clue font, which changes the font as the user types, shrinking it to match the available space. This capability is not provided for clues since they are supposed to be quite short. A color picker control allows the user to choose a default background color for text stimuli.

By providing visual variety to the user's task, stimulus covers make it more pleasant. They can be divided into either two categories (clue and answer as shown here) or four categories (1st stimulus, 2nd, 3rd, and 4th). In general, patterns make excellent stimulus covers because they are almost never confused with actual stimuli. No matter what the size of the image chosen by the user, Memory Weaver™ can produce a smaller version so that the image need not be compressed each time a stimulus cover is drawn. A “reset” button changes the covers back to the original images in the original configuration. A “new” button allows the user to browse his hard drive for suitable images.

A “Browse Stock Covers” button can allow the user to choose from images recommended for this purpose. The dialogue can show not only artwork but the web site of origin and other information about the artist, thus advertising a product. A “Browse Library” button can allow the user to browse an image library for suitable covers. Thus, users surfing the web for other purposes can also accumulate cover art in the stimulus library, using the same “Send to Memory Weaver™” button used for accumulating potential stimuli. A “four-cover view” of this can allow the user to set the appearance of the three clue stimuli individually. A “shuffle collection” can aggregate a plurality of user-chosen images, allowing a different pattern to show up on each stimulus cover within an exercise. Collections and other settings can be aggregated under theme names. A master collection can hold all the covers ever used. A separate collection can hold all the covers that could be used (drawn from the library, the web, and the hard drive). A stimulus cover module, similar to the library module discussed above, can allow users to trade their favorite collections of stimulus covers.

A “Mindset Flags” tab allows the user to flag individual mindsets according to their membership in user-defined groups. By default, the suggested groups can be . . .
Those flagged for review just prior to a test (red flag).
Those flagged for extra frequent review (yellow flag).
Those flagged as questions (blue flag).
Unassigned (green flag).

The user may change the flag descriptions. For example he might change “unassigned” to “Constitutional Amendment.” After a group description has been selected, the first letter in the description automatically populates the corresponding field in the letter column so if “Unassigned” were changed to “Constitutional Amendment,” the letter at left would change from ‘u’ to ‘c.’ The letter appears next to the flag and functions as a mnemonic that reminds the user of the flag's significance. The user may also type in a choice for the mnemonic letter. Mindset flags are used in conjunction with the Derivative Exercise Designer (described below) to isolate all the mindsets in an exercise that have been flagged as members of a special group. In one of the examples above, the user might want to assemble all the mindsets related to constitutional amendments for a test on the subject. To flag a mindset, the user clicks the flag which exposes a context menu listing the various ways in which it can be flagged.

b. Exporting and Importing Packages

Memory Weaver™ users can publish exercises. The reasoning behind the clues in a first user's mindset can be obscure but when two users are studying the same subject, they can trade exercises the way students trade stacks of flash cards. Each user obtains a fresh perspective on the material. Teachers and professors can publish their exercises to assist students in studying the material being taught. Memory Weaver™ relies on a library of images, sounds, video clips, and similar stimuli. Any non-text stimulus used in the program is copied to the library where it can be labeled and reused. Library content will vary from user to user because the library is augmented whenever a user chooses non text stimuli for new mindsets in the course of studying. In order to ensure that a user receiving an exercise has all the stimuli necessary to display its mindsets, a library module can be combined with the other information in the exercise and its mindsets. This library module is then added to the recipient's library when he imports the exercise so that the exercise can be displayed it in its entirety.

When a user wishes to share an exercise with another user, it must be packaged with the stimuli it would ordinarily pull from the library as needed. A file export wizard offers the user the option of packaging the original sounds and images or only thumbnails and clips taken from the originals. It then creates a library module which the recipient copy of Memory Weaver™ can import and unpack with the rest of the exercise. The import feature does the reverse of course. The library can also batch export stimuli into a folder (as ordinary files).

A mindset's context menu can include the option of sending the mindset to an E-mail (the same way files are sent to E-mail). Actual stimuli and graphics showing the shape outline of the mindset can be combined with code animating the mindset so that it could expose its clue list and answer separately, on demand by the e-mail recipient.

c. Text Search

Memory Weaver™'s text-search feature searches all text associated with an exercise, and can open and search all the exercise files in a given folder and subfolders of that folder. When a broader search is performed, exercise files containing hits can be opened and displayed so that the hits appear. Within an exercise, the search can begin at the location of the input focus and move forward (right and down). A Search can be initiated with a typical search dialogue then repeated with appropriate keyboard shortcuts (or clicking “Find Next”).

The types of information searched can be as follows:
Stimulus Source
   This information describes where a stimulus originates. Typical content can be, for example, www.teacherssite.com, www.addisonwesley.com, C:\Family Photos\Rick.jpg, and the like.
Stimulus “Key Words”
   A “key word” is a word that could serve as a description for a stimulus. The stimulus library can be stocked with images and sounds that have been pre-labeled with key words. For example, a beach scene might have the following key words/phrases associated with it: beach, sand, ocean, swimming, lifeguard, vacation.
Stimulus Comment
Stimulus Text
   Only text stimuli have stimulus text. This is the actual text clue or text answer.
Mindset Source
   The mindset source is the exact location of the information encoded by the mindset. This might be a book title and page, number, a path and file name a URL, an expert's name, a cassette number, and the like.
Mindset Comment
   A comment associated with the mindset as a whole (not its stimuli).

The results of a text search can be presented to the user in the form of a conversation balloon that originates from the location of the search result with the search terms highlighted. The nature of the hit location (mindset comment, stimulus key word, mindset source, etc.) is also shown by the bolded text within the balloon. For example, the word, “swim” might be found in a series of words describing an image of a beach (“key words” or “stimulus descriptors”). The conversation balloon can appear to issue from the center of whichever object contains the match. If a search term is found in a text stimulus, no balloon is necessary since the text is already visible. If a search term is found in a mindset source, the balloon issues from the center of the mindset's drag handle. A search result associated with an answer can expose the answer, or an keep the answer behind an answer cover, displaying a balloon with a hyperlink that will expose the matching string and surrounding text that might tend to give away the answer Additionally, submerged mindsets are included in searches and matches are reported. Once a previously submerged mindset no longer contains the focus, it disappears again.

d. Dragging and Dropping

A Scratchpad can be an area in which stimuli are stored until they can be moved into a mindset. The image capture tool can send images to the scratchpad. Images and sounds found in the library can also be sent there. Stimuli can be dragged both into and out of the scratchpad. A stimulus being dragged into the scratchpad is being copied while one being dragged out of the scratchpad is merely moved since stimulus reuse is relatively rare. These behaviors can be altered with hotkeys such as control+drag (copy) and shift+drag (move).

When a stimulus is dropped between clues, it appears between them. By default, a stimulus may not be dragged onto itself but when this option is turned on, it's easy to create a compound stimulus with identical halves. This is rarely done because two identical stimuli usually equate to just one. When one stimulus is dragged on top of another, a compound clue is produced. For example, an image of an animal might be combined with a sound that animal makes. By default, when stimuli are dragged from point to point within the same mindset, they are moved—not copied—so the number of items in the clue list drops when stimuli within the clue list are combined. A triangle, representing a drop location, can indicate to a user which half of an underlying stimulus will be allotted to a stimulus currently being dragged. When stimuli are dragged outside of a mindset, the stimulus is copied for reuse. When an object (mindset, stimulus, or a collection of either) is dragged close to the lower or upper borders of an exercise window, the window scrolls in the appropriate direction.

Mindsets may be inserted between other mindsets but (by default) cannot overwrite mindsets in the recipient exercise. Equivalent copying and pasting functionality is provided for all of drag operations above, including insert before (ctrl+B), which has the effect of dragging between stimuli whereas ctrl+V and ctrl+insert paste into stimuli.

Pasting a stimulus . . .
when an embedded stimulus is focused, creates a compound clue containing all its original stimuli plus the newly pasted one.
when a stimulus is focused creates a compound stimulus unless the focused stimulus was empty (agnostic), in which case a single stimulus results.
when the clue list is focused appends the stimulus being pasted.
when the answer region is focused (empty and focused) populates the answer region.
when the mindset is focused appends the stimulus to the clue list.

Non-stimuli include text on the clipboard, bitmaps on the clipboard, image files on the clipboard, and sound files on the clipboard. These may be thought of as “naked” stimuli which must first be housed in a stimulus container. By contrast, when pasting into an agnostic stimulus, the container is already there and when pasting a stimulus, the container is being pasted.

e. Derivative Exercise Designer

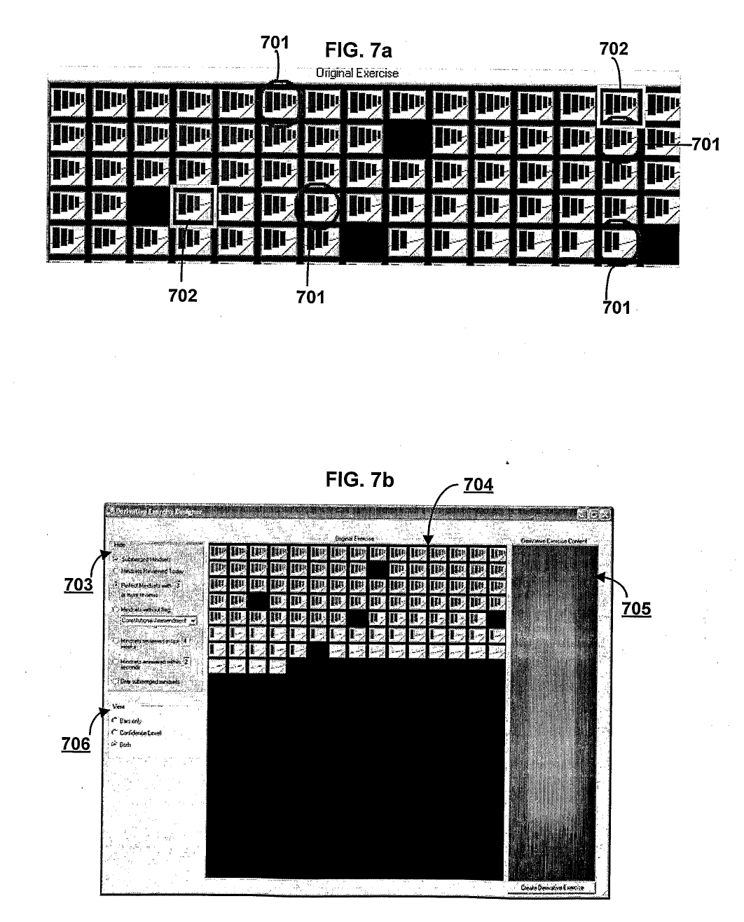

As users work with growing exercises, they soon find that they have practiced some mindsets more than others. Some mindsets have never been missed, while some need extra review. Others have always been missed. Others have been missed recently despite substantial practice. Others were missed early on but have never been missed since. These types of information are summarized visually by the mindset history control. Instead of displaying all the mindsets in an exercise, the Derivative Exercise Designer shows only their history controls as shown in FIG. 7a and FIG. 7b. This allows users to rapidly make rational choices about what to review. Any mindset which has been missed stands out because of its coloration.

The mindset history controls circled in FIG. 7a (701) represent mindsets that users can recognize as clear problems or potential problems. The two mindset history controls outlined in squares (702) are acceptable and do not need to be reviewed since the student has stopped missing them. Note that the history controls are arranged in descending order by review count. All the mindsets represented on the first row were reviewed 5 times. In the second row, a black square void signals the boundary between mindsets having five reviews and those having four, and so on.

The derivative exercise designer can have options available to the user as shown in FIG. 7b. For example, a “Hide . . . ” group box 703, in which the user may choose several options for reducing the number mindsets to be considered for review. Additionally, an “Original Exercise” control option 704 in which a subset of the history controls is displayed, and a “Derivative Exercise Content” control option 705, in which the history controls selected for review accumulate. A “View” option 706 can allow a user to view a the bars of the history controls, the confidence levels of the history controls, or both. A user can chose to review mindsets by clicking them. The user can select multiple mindsets by clicking or by dragging out a highlight rectangle, selecting many mindsets at once. Keyboard shortcuts provide equivalent functionality for all of the above. The history controls can show they have been selected by dimming and appearing in a “derivative exercise content” window. The content of the main exercise is not disturbed. From the user's perspective, the mindsets have been copied to a derivative exercise. The history controls can be expanded so that the associated mindset's clues become visible. This helps the user decide whether or not to include the mindset in the derivative exercise. The mindset answer remains hidden. The final step in the process is actual review of the derivative exercise. Afterwards, the history controls on some of the mindsets in the original exercise will reflect the fact they have been reviewed. These mindsets will also reflect an edits that took place during the review.

The derivative exercise designer is typically used to aggregate troublesome mindsets for extra study, to hide mindsets which do not need further study at the moment, to aggregate mindsets that were previously flagged, to review mindsets that have not been reviewed in a long time, and to aggregate only those mindsets that have been answered slowly.

f. Submersion

As the user reviews his exercises, he will often encounter facts he can remember for days, weeks, or months without additional review. To avoid unnecessary review of these mindsets, the user can “submerge” mindsets as they are encountered. A submerged mindset stays hidden for a user-specified period, then reappears of its own volition. A student might submerge a well-known mindset for a couple of months, having it reappear automatically a week before the final. Once the submersion period has been specified, the mindset hides itself for that period, then, “resurfaces” (reappears) in its original location so that any relationship it had with surrounding mindsets is not lost.

When a submerged mindset is forced to display itself before it is scheduled to resurface, it draws a green bar and minus sign indicating it can be re-hidden. Mindsets can be submerged in groups, therefore, if several adjacent mindsets are hidden this way, they can be forced to the surface and be re-hidden in groups.

g. Memory Weaver™ Library

i. The Library's Just-In-Time Services

The library can store files in their original sizes and formats so that no information is discarded. In order to reduce the memory requirements, the library passes stimuli to the interface on a “just-in-time” basis. In edit mode and the ordinary review mode (not close-up or full-screen), the library provides thumbnails for the interface rather than full-sized pictures. Similarly, the library passes only that portion of the original sound or video selected for actual play. Without these services, a modest exercise could occupy 100 megabytes or more, and expend billions of clock cycles just shrinking images. These library services also increase Memory Weaver™'s responsiveness.

ii. User Organization

When a stimulus is altered (a sound shortened, a video clipped, an image cropped, and the like), the library can place the altered version in a new file. When the user wants to see an image at its native resolution or use a different part of a sound he pulled from the web, it is the library that provides the original information. When the user captures a new image from the screen, drags an image in from a browser, pastes in a sound file from his hard drive, or records the correct pronunciation of a foreign word with a microphone, the new stimulus is copied to the library automatically so the user stays organized. A variety of key words may be associated with a stimulus to improve the odds of successfully retrieving it. A Stimulus Labeling Wizard (described below) aids users in processing new stimuli in batches. The user can search the library by specifying a variety of parameters, including the date a stimulus was added to the library, stimulus type, and key words. The library also counts the number of times each stimulus has been used. Typically, a stimulus that has been used four times has been used in four different mindsets to help convey four unrelated concepts but the fact that all four mindsets have one stimulus in common can trigger confusion in the user's memory—so the library warns the user when a single stimulus is relied upon too heavily.

iii. Exercise Sharing

When exercises are packaged for export (for sharing with other users), it is the library which provides the stimuli. When the user wishes to view exercises produced by other users, it is the library which imports the exercise by unpacking and storing any non text stimuli the user will need to view the exercise.

iv. Library Stores Digitized Versions of Textbook Graphics—and Non Printable Stimuli

Textbook publishers, test preparation companies, and study aid companies can produce library modules to complement their goods and services. Inside these modules, each graphic is labeled with, for example the publisher's unique reference number so that students can get digital versions of the images in their textbooks just by entering the reference numbers found next to those graphics in their text books. Publishers can provide reference numbers for non print stimuli as well—animations for example. The library supports customization for specific professions/subjects in a similar fashion. Companies can also create pre-made mindsets.

For example, a version of Memory Weaver™ might be customized to support the study of medicine by stocking its library with the following categories of well-labeled stimuli: images of organs, 3-D models of organs that can be rotated with an input device, photomicrographs of diseased tissue and microorganisms, sketches and electron photomicrographs of cellular anatomy and human anatomy, images of molecular shapes, rotatable molecular models, animations of metabolic processes, CAT scan data, MRI data, PET scan data, and video clips of processes, experiments, equipment, and procedures. Memory Weaver™ can interface one or more databases of medical imagery.

A module containing images of—and sounds emitted by—everyday objects and places can be useful for studying any language. Adjunct modules specific to a given language can contain the correct pronunciations of words, and special character sets. Alternatively Memory Weaver™ can access databases of such stimuli. A teacher working with an exercise from, for example, “Pimsleur®” can use these library modules to customize lectures based on it. Pimsleur® might sell bundles of such exercises directly to school systems, instructors, or directly to students. Pimsleur® could also provide access to such exercises and ancillary materials over the Internet.

Memory Weaver™ can support the publication of library modules and exercises on the Internet, allowing users to meet online and trade collections of stimulus covers and stimuli or pool well labeled stimuli (either at a central location or in a distributed fashion). Queries entertained by the library objects belonging to users participating in such groups would automatically extend their searches to include the libraries belonging to other file-sharing participants and/or a central database of well labeled stimuli accessible through the web. Users can specify which portions of their library's content they wish to share with other users. Shared portions of a library can respond to matching search requests by transmitting matching stimuli or compressed versions thereof to computers seeking them. Users studying similar subjects can meet online and swap exercises or e-mail mindsets to each other.

Copyright controls specific to individual stimuli can protect copyright owners who have conveyed rights in their works for inclusion in stimulus libraries and aftermarket library modules. Source information automatically collected as stimuli are added to individual libraries would facilitate the location of copyright owners by instructors who are designing their own lecture materials.

Corporate training programs, certification programs, and re-certification programs could all take advantage of the system by generating lecture materials containing individual mindsets (exposable through OLE or similar technologies) or entire exercises. The system greatly accelerates review, allowing employees pursuing recertification to finish much sooner.

Publishers can provide teachers with pre-fabricated lessons (exercises and documents containing isolated mindsets), Tests (exercises paired with multi-media multiple choice answers), and ancillary materials teachers can publish on their web sites to allow their students to design their own mindsets when studying on their own.

h. Stimulus Importing and Labeling Wizard

The Stimulus Importing and Labeling Wizard can have interfaces that are optimized for sorting and labeling—both very repetitive operations. Aspects of the main interface allow the piecemeal importation and labeling of stimuli but use of the wizard accelerates the process, allowing a user to sort stimuli just as fast as he can decide where they belong, and label the stimuli bound for the library just as fast as descriptions can be typed. Stimuli destined for the library are labeled on the way in. If the files are already in the library, they are simply labeled. As the user's personal files pass through each step, they are stamped: “Sorted”, then “imported” (labeled) so that the wizard won't accidentally import the same files twice. This means batch processing can be interrupted if necessary.

Some users will have substantial collections of stimuli they have created with cell phones, digital cameras, video cameras, and sound recording software. These stimuli will have been stored in folders on the user's hard drive. Other users will import most or all of their stimuli from the web, in which case the stimuli are already in the library. The wizard addresses both of these situations by providing an optional sort step in the labeling process.

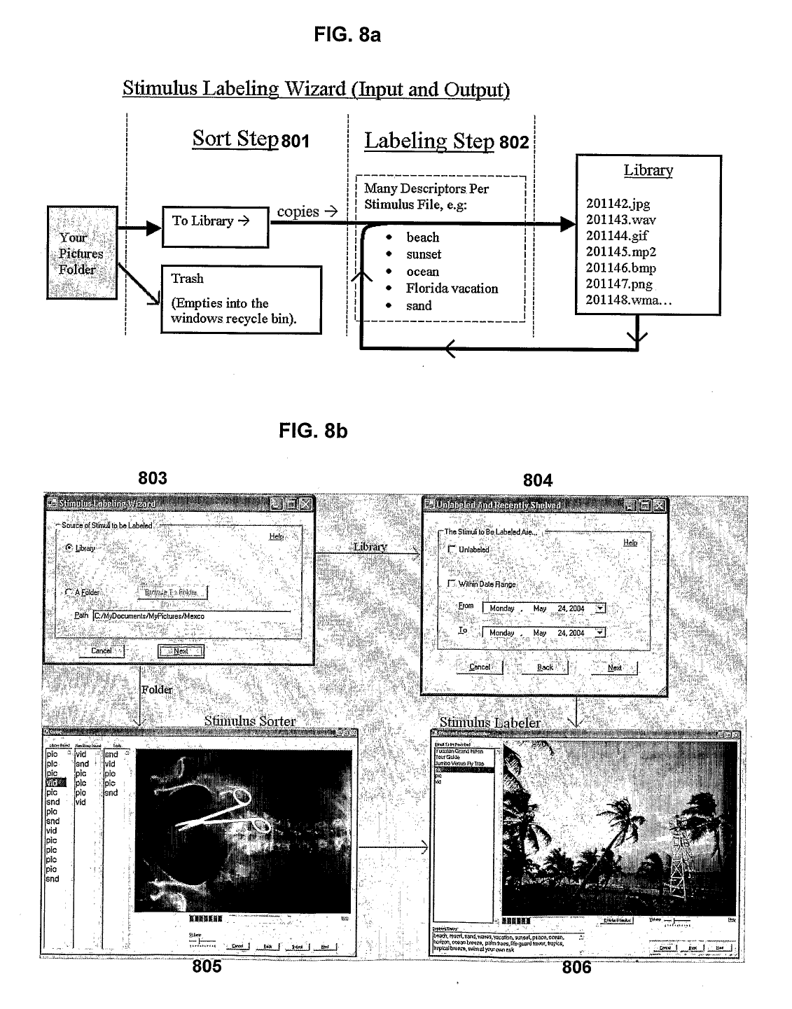

The user chooses which path to take through the wizard by specifying the location of the stimuli (folder or library), as shown by way of example in FIG. 8b, 803. If stimuli are already in the library, they need only be labeled as shown in 804. As shown in FIG. 8a, the wizard can comprise a sorting step 801 and a labeling step 802. If the user is importing stimuli from a folder on a hard drive, images and sounds of low quality should be removed during the sorting step before placing the best stimuli in the library 801 (and taking the time to label them). There is no need to label a stimulus which is not library-bound. As shown in 805, a sorter interface can present the folder's contents as belonging to one of three categories (library bound, non-library bound, and trash bound). To minimize the amount of sorting required, the interface assumes all stimuli will be copied into the library. To prevent a stimulus from being copied into the library, the user can move the stimulus into the “non-library bound” category—either by dragging or with keyboard shortcuts. Either way, the original stimulus files do not move. If a stimulus is placed into the “trash” category, it is deleted from the original folder during the transition to the next step.

When a stimulus file receives focus, the corresponding stimulus can be played or presented. Once this stimulus file loses focus, it can be labeled “sorted: N” where, “N” is a destination code based on which category contained the item when it lost the focus. N's possible values can be: Library, Current folder, and Trash. Stimulus file extensions are translated into type information (pic-picture, vid-video, snd-sound, etc). Since each stimulus can have multiple descriptions, file names like “Nikon 000347.jpg” and “David and Nancy at the beach.jpg” are usually immaterial but all file properties can be displayed to help the user distinguish among nearly identical stimuli by modification date, file size, name, and so on. As stimuli in the folder are inspected, their associated designations can change color so the user can see which stimuli have been sorted. If the user enters the labeling step before all the stimuli have been sorted, only sorted/inspected stimuli will proceed to the labeling step.

In the labeling step 802, as in the previous step, each stimulus is displayed when it receives focus. The user can type, using an interface such as 806, descriptive, “key” words and use a hotkey to move the focus down to the next stimulus. The new stimulus is displayed as a description window is cleared in advance of the new description. When the user is finished labeling the stimuli, the stimulus files are labeled “imported,” and copied into the library.

During the sorting step, a stimulus-source stamp stamps each library bound stimulus object with information about where the stimulus was found (typically a path and file name but the information stamped can be modified by the user as necessary). Alternatively, the stimulus-source stamp might be set with a URL, A publisher and title combination, a copyright owner's name and contract ID, etc.

i. Grammar and Slaved Text Stimuli

A memory model implemented by Memory Weaver™ indicates that the most effective way of studying grammar is by “blanking out” the words in a sentence in a scattered fashion, allowing the user to imagine how the blanks are filled a few times, then restoring the words so that a new selection of words in the same sentence can be blanked out. The process is repeated until the rules of grammar which guided the construction of the sentence are thoroughly understood. When scattered words are removed from a sentence, the remaining words provide the best clues for determining what the missing words were. For example, in the sentence, “______ jogs everyday” The missing word can be “he” or “she” since: 1) “Jog” is a verb used primarily in reference to humans. 2) The verb is conjugated in the third person singular. An ancillary clue (perhaps an image of a male) would eliminate “she” from the collection of possible answers. A similar process would teach the rules of spelling. In this usage, the user would blank out isolated letters from a single word. Ancillary spelling clues might include the sound of the word being spoken, rhyming words, the spelling rule that applies, the derivation of the word, or a depiction of the word.

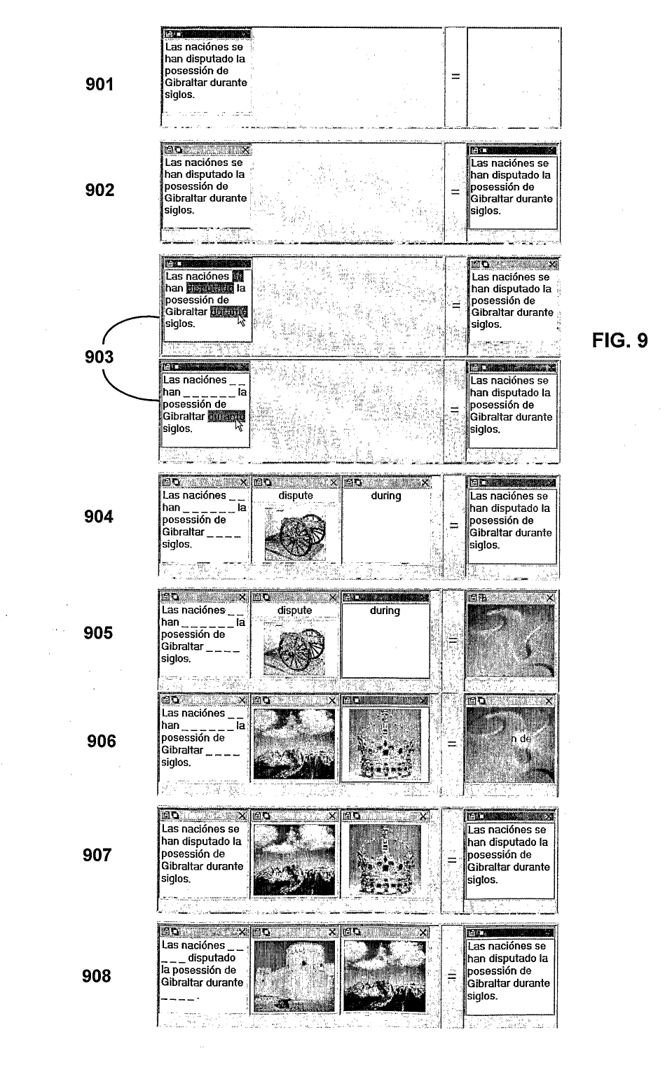

A method for implementing the aforementioned memory model is illustrated in FIG. 9. At 901, a user identifies a sentence containing new grammatical constructs, and types or pastes the sentence into a clue. At 902, the user creates a special type of answer that is slaved to the original clue so as to mirror its content in a special way. Both stimuli use a “max possible” font that shrinks as the user types so as to fill the available space without forcing the user to adjust font sizes. At 903, the user chooses several new blanks by highlighting the words to be hidden (by double clicking for example). As each highlight operation is completed, the word disappears, being replaced by a set of discrete blanks (_{— — — —}) matching the word's letter count. Meanwhile, the slaved answer colors its corresponding words brightly so the user will be able to check the answer quickly. At 904, the user adds any additional clues necessary—a cannon, “dispute,” and “during” in this example. At 905, the user reviews the mindset until the missing words can confidently be produced.

Modifications made to either of the slaved stimuli during subsequent reviews are also illustrated in FIG. 9. At 906, the user colors the preposition, “de” red in one of the stimuli, causing the color change to appear in both, and making this aspect of the grammatical construct stand out. Modifications of the non-slaved stimuli cause no changes.

At 907, if the user is satisfied with his performance, the user can reset the slaved stimuli so that the blanks disappear and the user repeats the process by selecting a different set of blank words within the same sentence, as shown at 908. This time, the user blanked out “se” again but blanked out two new words, “han” and “siglos” instead of, “disputado” and “durante.” To accelerate the study of foreign grammar, digitized articles allow sentences to be imported into slaved text stimuli with a single double-click.

Memory Weaver™ can be used to teach or study foreign vocabulary by using words the student or students already know as clues that help trigger the recall of new vocabulary hidden in the answer. This approach makes review an integral part of the learning process. In the example below, students studying English as a second language have already learned the words car, wasp, and sting so these make good clues for teaching or studying the English word accident.

[car, wasp, sting]=accident.

In addition to providing opportunities for review, the clues provide critical context which is often absent with other learning approaches, which often rely on “translation.” For example, the Spanish word, “casco” may be translated as either helmet, hoof, or headset. The correct translation depends on the surrounding words. Memory Weaver™ uses the surrounding words as clues. Thus a mindset for the study of “casco” might be constructed this way:

[horse, horseshoe, repair]=casco.

In this case, the correct translation is hoof—not headset or helmet. Another approach to studying words with multiple definitions is to use the definitions in the clues. In this situation, students studying English might produce this, mindset:

[a precise location, a valid argument, a sharp end]=a point.

In English, there are often many ways to spell the same sound. Some of these fit “spelling patterns” while others, called “spelling exceptions” do not fit any patterns. Memory Weaver™ provides ways of learning spelling patterns, their exceptions, and even both at once. For example, the mindset

[ce, ci, cy]=ssssss

illustrates the teaching and study of the “soft C” spelling pattern while

[ca, co, cu]=k

illustrates the teaching and study of the “hard C” spelling pattern. This mindset

[to, two, means “also”]=too (zoo, goo, moo . . . )

has spelling exceptions in the first two clues, and a spelling pattern (_oo) in the answer so the user is learning both the pattern and its exceptions at the same time.

j. Page Stamp

When students have questions, need to quote authorities, or are writing bibliographies, they need a way to backtrack from their notes (mindsets) to the information source being studied when the notes were taken. Reference information like book titles, page numbers, URL's, PowerPoint file names, and slide numbers, can make that possible. The page stamp is a part of Memory Weaver™ that ensures reference information is always available. Users can run an exercise's text-searching feature to find a particular mindset and then examine that mindset's reference information to determine which book and page were being read at the time. The page stamp's role is to ensure that the reference information gets stamped on the mindset and to ensure that the reference information is accurate. The page stamp can be docked on one side of an interface or set to pop up every time the user finishes a mindset. Each time a mindset is completed, it is stamped with the page number and book title (or similar reference information) stored in the page stamp.

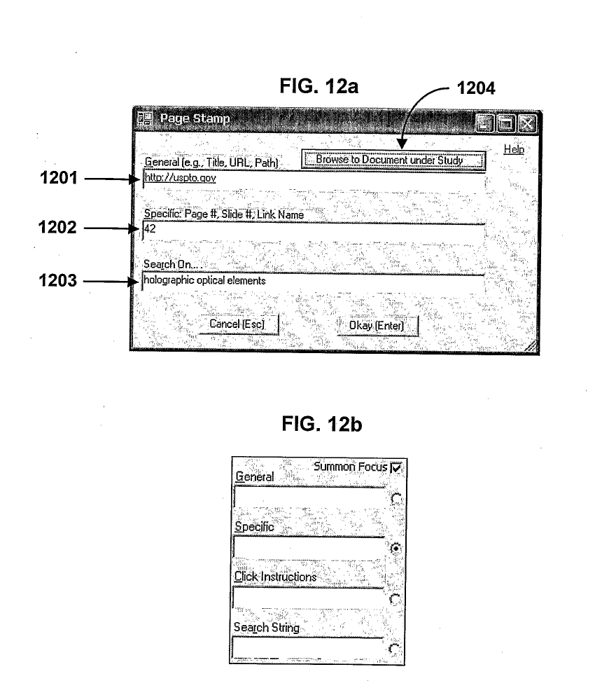

An exemplary Page Stamp interface is illustrated in FIG. 12a. The “General” field 1201 is used for location information that does not change very often, like book titles and web sites. The “Specific” section 1202 is used for information like page numbers and PowerPoint slide numbers, which may change with every new mindset. The “Search On . . . ” section 1203 can use search Strings to help isolate the correct passage in any type of electronic document. For example, a user could type “holographic optical elements” into MS Word's “Find” feature to locate the correct passage instantly.

When the page stamp has been set to pop up after the completion of every mindset, it remembers which field contained the input focus when it was dismissed. Each time it appears, the contents of that field are focused and highlighted so that they can be quickly replaced (typed over) or accepted (<enter>). Reading a textbook, the user would simply type the book's title into the general field the first time the page stamp appears, then move to the, “Specific” field, and enter the number of the page he's taking notes on. Each time the page stamp reappears, the user either updates the page number or hits enter to dismiss it again (because he is still on the same page).

A “Browse to Document under Study” button 1204 can bring up a standard browse dialogue which takes the user to the electronic document being studied. When the user identifies the document by double clicking the document's icon in the browse window, the document path and filename are encapsulated in a hyperlink which is placed in the “General” field of the page stamp. Now each mindset the user creates is stamped with this hyperlink so that he can return to the exact file instantly by clicking on it in the corresponding field of the mindset properties pad, described below.

An example of how the page stamp can look like this when it is docked is shown in FIG. 12b. As the user completes a mindset, he typically tabs off the answer because this creates a new mindset but when “Summon Focus” is checked, the “radio buttons” on the right are activated. Now the user's tab is interpreted by focusing the “Specific” field and highlighting its contents so that they can be accepted or changed. The user must hit tab one more time to accept the current page number and start the next mindset. When the page stamp is docked, the “Browse to Document under Study” feature can be available on its context menu together with docking options. “Click instructions are instructions that describe how a user with an imprecise URL can navigate from a home page to the actual source material for the mindset. For example, click instructions can be, “Left frame, ‘Investigations of Electricity’, 2nd paragraph ‘Ben's kite experiment’, scroll to bottom.”

k. Properties Pads

A mindset properties pad displays the most useful information about the mindset through a comment field. The comment field can accept rich text: maps, bulleted lists, hyperlinks, and the like. A “hide” toggle button can force the comment to remain hidden until the answer has been revealed. As focus moves from mindset to mindset, the contents of the mindset properties pad change but the content of the page stamp remains constant. To avoid attracting the user's eye to information which might tend to give away the answer, the opacity of the text can rise gradually after each content change.

When an image, sound, or similar file is brought into Memory Weaver™ from the hard drive or the web, a stimulus location field is populated automatically with the path to the stimulus or its URL and is generally not modified by the user. The key words that the library's labeling wizard collects are also visible through the properties pad. The key word list can also be amended here. A stimulus reference information field can be used for bibliographic data and/or copyright data. The content of the Stimulus Properties Pad changes as the focus moves from stimulus to stimulus.

l. Submergible Message Boxes

Submergible message boxes provide a user a way to be reminded of important features that do not need to be learned immediately. The submergible message boxes can be subject to a user-determined choice between constant annoyance and never seeing the message again. These message boxes can contain information to help a user with Memory Weaver™. The submergible message boxes can include a “favorites” feature, allowing the aggregation of messages the user expects to review and use eventually. The messages contained in the submergible message boxes support rich text for displaying diagrams, bulleted lists, colored text, clipboard copying, and hyperlinks.

A submergible message box can determine the location of a mouse pointer, allowing a default button to be generated directly under the pointer. An advantage of this approach is that the user can always see the message promptly since the user's fovea already points at the mouse. Another advantage is that the user need not traverse the screen with a mouse pointer to dismiss the message.

To prevent the user from accidentally dismissing a message that popped up under the mouse pointer while double-clicking, the default button has an activation delay feature so the user has a chance to read and respond to the message. The second click of a double-click is ignored so that the user has had a chance to read and respond to the message.

### V. Exemplary Operating Environment

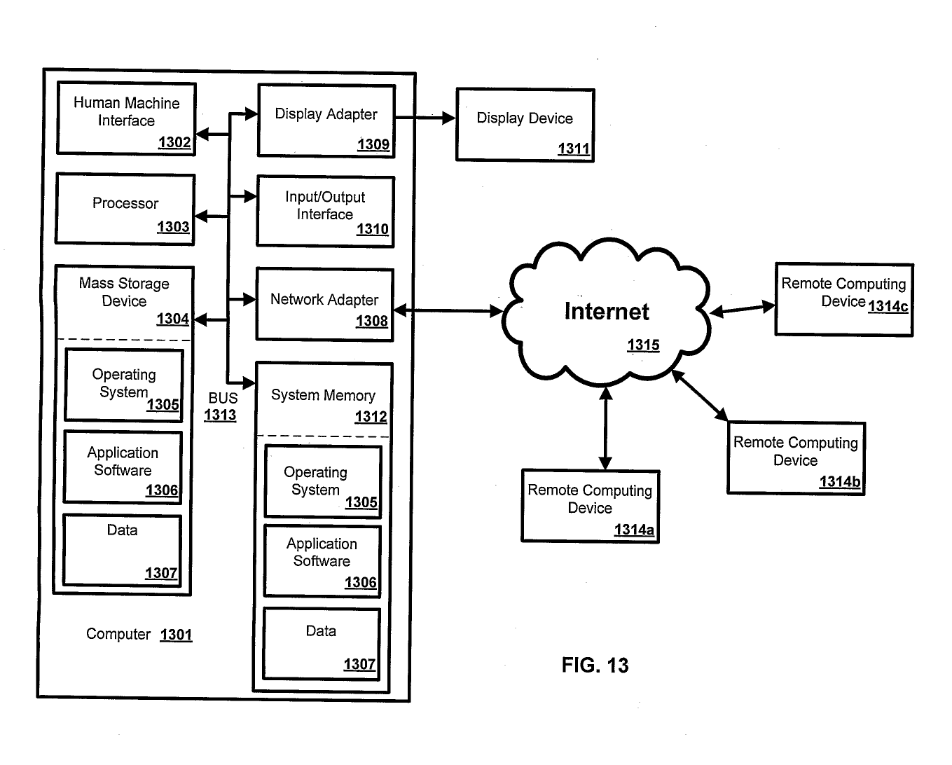

FIG. 13 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The method can be operational with numerous other general purpose or special purpose computing system environments or configurations. Examples of well known computing systems, environments, and/or configurations that may be suitable for use with the system and method include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The method may be described in the general context of computer instructions, such as program modules, being executed by a computer. Generally, program modules include routines, programs, objects, components, data structures, etc. that perform particular tasks or implement particular abstract data types. The system and method may also be practiced in distributed computing environments where tasks are performed by remote processing devices that are linked through a communications network. In a distributed computing environment, program modules may be located in both local and remote computer storage media including memory storage devices.

The method disclosed herein can be implemented via a general-purpose computing device in the form of a computer 1301. The components of the computer 1301 can include, but are not limited to, one or more processors or processing units 1303, a system memory 1312, and a system bus 1313 that couples various system components including the processor 1303 to the system memory 1312.

The system bus 1313 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 1313, and all buses specified in this description can also be implemented over a wired or wireless network connection and each of the subsystems, including the processor 1303, a mass storage device 1304, an operating system 1305, application software 1306, data 1307, a network adapter 1308, system memory 1312, an Input/Output Interface 1310, a display adapter 1309, a display device 1311, and a human machine interface 1302, can be contained within one or more remote computing devices 1315a,b,c at physically separate locations, connected through buses of this form, in effect implementing a fully distributed system.

The computer 1301 typically includes a variety of computer readable media. Such media can be any available media that is accessible by the computer 1301 and includes both volatile and non-volatile media, removable and non-removable media. The system memory 1312 includes computer readable media in the form of volatile memory, such as random access memory (RAM), and/or non-volatile memory, such as read only memory (ROM). The system memory 1312 typically contains data such as data 1307 and/or program modules such as operating system 1305 and application software 1306 that are immediately accessible to and/or are presently operated on by the processing unit 1303.

The computer 1301 may also include other removable/non-removable, volatile/non-volatile computer storage media. By way of example, FIG. 4 illustrates a mass storage device 1304 which can provide non-volatile storage of computer code, computer readable instructions, data structures, program modules, and other data for the computer 1301. For example, a mass storage device 1304 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 1304, including by way of example, an operating system 1305 and application software 1306. Each of the operating system 1305 and application software 1306 (or some combination thereof) may include elements of the programming and the application software 1306. Data 1307 can also be stored on the mass storage device 1304. Data 1307 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 1301 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 1303 via a human machine interface 1302 that is coupled to the system bus 1313, but may be connected by other interface and bus structures, such as a parallel port, game port, or a universal serial bus (USB).

A display device 1311 can also be connected to the system bus 1313 via an interface, such as a display adapter 1309. For example, a display device can be a monitor or an LCD (Liquid Crystal Display). In addition to the display device 1311, other output peripheral devices can include components such as speakers (not shown) and a printer (not shown) which can be connected to the computer 1301 via Input/Output Interface 1310.

The computer 1301 can operate in a networked environment using logical connections to one or more remote computing devices 1315a,b,c. By way of example, a remote computing device can be a personal computer, portable computer, a server, a router, a network computer, a peer device or other common network node, and so on. Logical connections between the computer 1301 and a remote computing device 1315a,b,c can be made via a local area network (LAN) and a general wide area network (WAN). Such network connections can be through a network adapter 1308. A network adapter 1308 can be implemented in both wired and wireless environments. Such networking environments are commonplace in offices, enterprise-wide computer networks, intranets, and the Internet 1315.

For purposes of illustration, application programs and other executable program components such as the operating system 1305 are illustrated herein as discrete blocks, although it is recognized that such programs and components reside at various times in different storage components of the computing device 1301, and are executed by the data processor(s) of the computer. An implementation of application software 1306 may be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed method can be performed by software components. The disclosed method may be described in the general context of computer-executable instructions, such as program modules, being executed by one or more computers or other devices. Generally, program modules include computer code, routines, programs, objects, components, data structures, etc. that performs particular tasks or implement particular abstract data types. The disclosed method may also be practiced in grid-based and distributed computing environments where tasks are performed by remote processing devices that are linked through a communications network. In a distributed computing environment, program modules may be located in both local and remote computer storage media including memory storage devices.

While this invention has been described in connection with preferred embodiments and specific examples, it is not intended that the scope of the invention be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method of teaching a student, comprising:
selecting a first exercise comprising a first mindset, wherein the first mindset comprises a first clue, a second clue and an answer, wherein the first clue and the second clue of the first mindset have a relationship and wherein the relationship is revealed by the answer;
exposing the first clue and the second clue to the student; and
exposing the answer to the student.

2. The method of claim 1, wherein the first mindset further comprises a third clue, wherein the third clue has a second relationship to at least one of the first clue and the second clue.

3. The method of claim 2, wherein the first relationship and the second relationship is the same.

4. The method of claim 1, further comprising providing a second exercise to the student.

5. The method of claim 1, wherein the first exercise further comprises a second mindset having a clue corresponding to the answer of the first mindset.

6. The method of claim 1, wherein the first clue is exposed before the second clue.

7. The method of claim 1, wherein the first clue is selected from a group consisting of:
plain text;
rich text;
an image;
an animation;
a video clip;
a sound clip;
a music clip;
a speech clip;
a hologram;
a scent;
direct brain stimulation; and
a compound clue.

8. The method of claim 1, wherein the clues are input into a computer system via speech recognition.

9. The method of claim 1, wherein the answer exposed is a possible answer and further comprising:
receiving a vote submitted by the student regarding the correctness of the possible answer; and
determining whether the student understood the first relationship based on the vote received.

10. The method of claim 9, further comprising:
assigning a grade to the student based on the vote submitted by the student.

11. The method of claim 9, further comprising assigning an efficacy score to the mindset based on the correctness of the student's vote.

12. The method of claim 1 further comprising retrieving a historical performance for the student.

13. The method of claim 1, wherein the first clue is selected from a library.

14. The method of claim 1, wherein after exposing the first clue, editing the first clue.

15. The method of claim 1, wherein after exposing the answer, editing the answer.

16. The method of claim 1, wherein after exposing the first clue, the second clue and the answer, changing the order in which the first clue, the second clue and the answer are to be exposed.

17. The method of claim 1, further comprising linking related but scattered mindsets in an ordered loop allowing a user to traverse the loop by visiting all the related mindsets before returning to a starting mindset.

18. The method of claim 1, wherein the mindset is obtained from a mindset sharing system.

19. The method of claim 1, further comprising a clue cover and an answer cover.

20. The method of claim 19, wherein the covers are obtained from a cover sharing system.

21. The method of claim 1, wherein the clues and answers are obtained from a stimulus sharing system.

22. The method of claim 1, wherein the first mindset is selectively submerged by a student wherein the mindset is not available to the student until a predetermined time has passed.

23. The method of claim 1, further comprising a plurality of mindsets wherein a user can modify the order of the plurality of mindsets.

24. The method of claim 1, wherein a clue is an image obtained from a screen capture.

25. The method of claim 1, wherein the exercise is obtained from an exercise sharing system.

26. A method of taking notes, comprising:
identifying a fact;
decomposing the fact into two concepts having a first relationship;
converting each concept into a clue;
creating an answer which reveals the first relationship between the first clue and the second clue; and
associating the first clue, the second clue and the answer in a mindset.

27. The method of claim 26, wherein after associating the first clue, the second clue, and the answer in a mindset, editing the first clue.

28. The method of claim 26, further comprising:
decomposing the fact into a third concept having a second relationship to the two concepts;
converting the third concept into a clue; and
associating the clue in the mindset.

29. The method of claim 26, wherein the first clue is selected from a library.

30. The method of claim 26, further comprising generating a second mindset from a second fact.

31. The method of claim 26, wherein after associating the first clue, the second clue and the answer in a mindset, editing the answer.

32. The method of claim 26, wherein after associating the first clue, the second clue and the answer in a mindset, changing the order in which the first clue, the second clue and the answer are to be exposed.

33. The method of claim 26, further comprising linking related but scattered mindsets in an ordered loop allowing a user to traverse the loop by visiting all the related mindsets before returning to a starting mindset.

34. The method of claim 26, wherein the mindset is obtained from a mindset sharing system.

35. The method of claim 26, further comprising a clue cover and an answer cover.

36. The method of claim 35, wherein the covers are obtained from a cover sharing system.

37. The method of claim 26, wherein the clues and answers are obtained from a stimulus sharing system.

38. The method of claim 26, further comprising conveying a student's past performance.

39. The method of claim 38, wherein conveying the student's past performance comprises using a plurality of vertical lines having a plurality of colors, organized with a false perspective.

40. The method of claim 26, wherein the clues further comprise a page stamp indicating the source of the fact.
